(19) United States
(12) Patent Application Publication
(10) Pub. No.: US 2021/0054149 A1
(43) Pub. Date: Feb. 25, 2021

(54) SILANE COMPOUND INCLUDING FLUORINE-CONTAINING POLY(ETHER) GROUP, COMPOSITION INCLUDING THE SAME, FILM FORMED FROM THE COMPOSITION, DISPLAY DEVICE, AND ARTICLE

(71) Applicant: Samsung Electronics Co., Ltd., Suwon-si (KR)

(72) Inventors: Hana Kim, Yongin-si (KR); Byungha Park, Suwon-si (KR); Kyeongsik Ju, Suwon-si (KR); Sunghun Hong, Hwaseong-si (KR)

(21) Appl. No.: 16/990,124

(22) Filed: Aug. 11, 2020

(30) Foreign Application Priority Data
Aug. 21, 2019 (KR) 10-2019-0102455

(51) Int. Cl. C08G 77/26; C08J 5/18; C09D 183/08; C07F 7/08

(52) U.S. Cl. CPC C08G 77/26; C08J 5/18; C08J 2383/08; C07F 7/081; C08G 2150/00; C09D 183/08

(57) ABSTRACT

Disclosed are a composition containing a silane compound including a fluorine-containing poly(ether) group, the silane compound being represented by Formula 1, a film formed from the composition, a display device including the film, and an article including the composition,

Rf-(L¹)ₚ₁-Q1-(L²)ₚ₂-Si(R₁)(R₂)-(L³)ₚ₃-Si(R₃)(R₄)(R₅) Formula 1

wherein, in Formula 1, Rf is a fluorine-containing poly(ether) group, and Q1, L¹ to L⁵, R₁ to R₅, R₉ to R₁₃, and p1 to p5 are as defined in the specification.

### CROSS-REFERENCE TO RELATED APPLICATION

This application claims priority to and the benefit of Korean Patent Application No. 10-2019-0102455, filed on Aug. 21, 2019, in the Korean Intellectual Property Office, and all the benefits accruing therefrom under 35 U.S.C. § 119, the content of which is incorporated herein in its entirety by reference.

### BACKGROUND

### 1. Field

The present disclosure relates to a silane compound including a fluorine-containing poly(ether) group, a composition including the same, a film formed from the same, a display including the film, and an article including the composition.

### 2. Description of Related Art

Functional layers having various functions may be applied to portable electronic devices such as smart phones or tablet PCs. In particular, as touch screen panels which recognize the position of the touch of a finger or a tool have become more common, functional layers may be applied onto surfaces of display panels in order to improve the slipperiness and touch of the surface of the touch screen panels.

However, such a functional layer may have poor durability and may be easily lost or damaged due to frequent contact, and thus the function of the layer may be degraded. Accordingly, there is a need for improvement in this regard.

### SUMMARY

Provided are a novel silane compound including a fluorine-containing poly(ether) group, and a composition including the novel silane compound that is, capable of improving durability.

Provided is a film which is formed of the composition to provide improved durability.

Provided is a display device including the film.

Provided is an article coated with the composition.

Additional aspects will be set forth in part in the description which follows and, in part, will be apparent from the description, or may be learned by practice of the presented embodiments of the disclosure.

According to an aspect, there is provided a silane compound including a fluorine-containing poly(ether) group, the silane compound being represented by Formula 1:

Rf-(L¹)ₚ₁-Q1-(L²)ₚ₂-Si(R₁)(R₂)-(L³)ₚ₃-Si(R₃)(R₄)(R₅) Formula 1

wherein, in Formula 1,

Rf is a fluorine-containing poly(ether) group,

Q1 may be —O—, —C(═O)O—, —O—C(═O)O—, —NR^{a}C(═O)O—, —C(═O)NR^{b}—, —OC(═O)NR^{c}S(═O)O—, or —CH₂(C₆H₄)C(═O)—, wherein R^{a} to R^{c} may each independently be hydrogen, a substituted or unsubstituted C1 to C20 alkyl group, a substituted or unsubstituted C6 to C20 aryl group, or a combination thereof,

L¹ and L³ may each independently be a substituted or unsubstituted C1 to C20 alkylene group, a substituted or unsubstituted C1 to C20 oxyalkylene group, or a combination thereof,

L² may be a substituted or unsubstituted C1 to C20 alkylene group, a substituted or unsubstituted C1 to C20 oxyalkylene group, —(CH₂)ₘ—NH—(CH₂)ₙ— wherein m and n may each independently be an integer of 1 to 10, or a combination thereof,

p1 to p3 may each independently be an integer of 1 to 10,

R₁ to R₅ may each independently be hydrogen, a substituted or unsubstituted C1 to C20 alkoxy group, a halogen atom, a hydroxyl group, a substituted or unsubstituted C1 to C20 alkyl group, a substituted or unsubstituted C6 to C20 aryl group, or a combination thereof,

wherein at least one of R₁ to R₅ may be a substituted or unsubstituted C1 to C20 alkoxy group, a halogen atom, or a hydroxyl group, or

at least one of R₃ to R₅ may be -(L⁴)ₚ₄-Si(R₉)(R₁₀)(R₁₁), or -(L⁴)ₚ₄-Si(R₁₂)(R₁₃)-(L⁵)ₚ₅-Si(R₉)(R₁₀)(R₁₁), and each of the other R₃ to R₅ may be a substituted or unsubstituted C1 to C20 alkoxy group, a halogen atom, or a hydroxyl group,

wherein R₉ to R₁₃ may each independently be hydrogen, a substituted or unsubstituted C1 to C20 alkoxy group, a halogen atom, a hydroxyl group, a substituted or unsubstituted C1 to C20 alkyl group, a substituted or unsubstituted C6 to C20 aryl group, or a combination thereof, wherein at least one of R₁₁ to R₁₃ is a substituted or unsubstituted C1 to C20 alkoxy group, a halogen atom, or a hydroxyl group,

L⁴ and L⁵ may each independently be a substituted or unsubstituted C1 to C20 alkylene group, a substituted or unsubstituted C1 to C20 oxyalkylene group, or a combination thereof, and

p4 and p5 may each independently be an integer of 1 to 10.

According to another aspect, there is provided a composition including the above-described silane compound including a fluorine-containing poly(ether) group and being represented by Formula 1.

According to another aspect, there is provided a composition including a compound represented by Formula 2:

H₂N-(L²)ₚ₂-Si(R₁)(R₂)-(L³)ₚ₃-Si(R₃)(R₄)(R₅) Formula 2

wherein, in Formula 2,

L² may be a substituted or unsubstituted C1 to C20 alkylene group, a substituted or unsubstituted C1 to C20 oxyalkylene group, —(CH₂)ₘ—NH—(CH₂)ₙ— wherein m and n may each independently be an integer of 1 to 10, or a combination thereof,

L³ may be a substituted or unsubstituted C1 to C20 alkylene group, a substituted or unsubstituted C1 to C20 oxyalkylene group, or a combination thereof,

p2 and p3 may each independently be an integer of 1 to 10,

R₁ to R₅ may each independently be hydrogen, a substituted or unsubstituted C1 to C20 alkoxy group, a halogen atom, a hydroxyl group, a substituted or unsubstituted C1 to C20 alkyl group, a substituted or unsubstituted C6 to C20 aryl group, or a combination thereof,

wherein, at least one of R₁ to R₅ may be a substituted or unsubstituted C1 to C20 alkoxy group, a halogen atom, or a hydroxyl group, or

at least one of R₃ to R₅ may be -(L⁴)ₚ₄-Si(R₉)(R₁₀)(R₁₁), or -(L⁴)ₚ₄-Si(R₁₂)(R₁₃)-(L⁵)ₚ₅-Si(R₉)(R₁₀)(R₁₁), and each of the other R₃ to R₅ may be a substituted or unsubstituted C1 to C20 alkoxy group, a halogen atom, or a hydroxyl group,

wherein R₉ to R₁₃ may each independently be hydrogen, a substituted or unsubstituted C1 to C20 alkoxy group, a halogen atom, a hydroxyl group, a substituted or unsubstituted C1 to C20 alkyl group, a substituted or unsubstituted C6 to C20 aryl group, or a combination thereof, wherein at least one of R₉ to R₁₃ may be a substituted or unsubstituted C1 to C20 alkoxy group, a halogen atom or a hydroxyl group,

L⁴ and L⁵ may each independently be a substituted or unsubstituted C1 to C20 alkylene group, a substituted or unsubstituted C1 to C20 oxyalkylene group, or a combination thereof, and

p4 and p5 may each independently be an integer of 1 to 10.

According to another aspect, there is provided a film including the products of hydrolysis and condensation polymerization of a silane compound including a fluorine-containing poly(ether) group, the silane compound being represented by Formula 1 above.

In one or more embodiments, the film may further include the compound represented by Formula 2, a compound represented by Formula 3, or a combination thereof,

A-L⁶-Si(R₅)(R₆)(R₇). Formula 3

wherein in Formula 3,

L⁶ may be a substituted or unsubstituted C1 to C20 alkylene group, a substituted or unsubstituted C6 to C20 arylene group, or a combination thereof,

R₅ to R₇ may each independently be hydrogen, a substituted or unsubstituted C1 to C20 alkoxy group, a halogen atom, a hydroxyl group, a substituted or unsubstituted C1 to C20 alkyl group, a substituted or unsubstituted C6 to C20 aryl group, or a combination thereof,

A may be a halogen, a thiol group, an isocyanate group, or an amino group, and

at least one of R₅ to R₇ may be a substituted or unsubstituted C1 to C20 alkoxy group, a halogen atom, or a hydroxyl group.

According to another aspect, there is provided a film including i) i-1) products of hydrolysis and condensation polymerization of the silane compound including a fluorine-containing poly(ether) group and being represented by Formula 1 and a silane compound represented by Formula 4, and i-2) a compound represented by Formula 2, or ii) products of hydrolysis and condensation polymerization of a mixture including the silane compound including the fluorine-containing poly(ether) group and being represented by Formula 1, a silane compound represented by Formula 4, and a compound represented by Formula 2.

H₂N-(L²)ₚ₂-Si(R₁)(R₂)-(L³)ₚ₃-Si(R₃)(R₄)(R₅) Formula 2

### In Formula 2,

L² may be a substituted or unsubstituted C1 to C20 alkylene group, a substituted or unsubstituted C1 to C20 oxyalkylene group, —(CH₂)ₘ—NH—(CH₂)ₙ— wherein m and n may each independently be an integer of 1 to 10, or a combination thereof,

L³ may each independently be a substituted or unsubstituted C1 to C20 alkylene group, a substituted or unsubstituted C1 to C20 oxyalkylene group, or a combination thereof,

p2 and p3 may each independently be an integer of 1 to 10,

R₁ to R₅ may each independently be hydrogen, a substituted or unsubstituted C1 to C20 alkoxy group, a halogen atom, a hydroxyl group, a substituted or unsubstituted C1 to C20 alkyl group, a substituted or unsubstituted C6 to C20 aryl group, or a combination thereof,

wherein at least one of R₁ to R₅ may be a substituted or unsubstituted C1 to C20 alkoxy group, a halogen atom, or a hydroxyl group, or

at least one of R₃ to R₅ may be -(L⁴)ₚ₄-Si(R₉)(R₁₀)(R₁₁), or -(L⁴)ₚ₄-Si(R₁₂)(R₁₃)-(L⁵)ₚ₅-Si(R₉)(R₁₀)(R₁₁), and each of the other R₃ to R₅ may be a substituted or unsubstituted C1 to C20 alkoxy group, a halogen atom, or a hydroxyl group,

R₉ to R₁₃ may each independently be hydrogen, a substituted or unsubstituted C1 to C20 alkoxy group, a halogen atom, a hydroxyl group, a substituted or unsubstituted C1 to C20 alkyl group, a substituted or unsubstituted C6 to C20 aryl group, or a combination thereof, wherein at least one of R₉ to R₁₃ may be a substituted or unsubstituted C1 to C20 alkoxy group, a halogen atom, or a hydroxyl group,

L⁴ and L⁵ may each independently be a substituted or unsubstituted C1 to C20 alkylene group, a substituted or unsubstituted C1 to C20 oxyalkylene group, or a combination thereof, and

p4 and p5 may each independently be an integer of 1 to 10.

FpE-(L²)ₚ₁-LG-(L³)ₚ₂-SiR^{a}R^{b}R^{c} Formula 4

### In Formula 4,

FpE may be a fluorine-containing poly(ether) moiety,

R^{a}, R^{b} and R^{c} may each independently be hydrogen, a substituted or unsubstituted C1 to C20 alkoxy group, a halogen, a hydroxyl group, a substituted or unsubstituted C1 to C20 alkyl group, a substituted or unsubstituted C6 to C20 aryl group, or a combination thereof, wherein at least one of R^{a}, R^{b} and R^{c} may be a substituted or unsubstituted C1 to C20 alkoxy group, a halogen, or a hydroxyl group,

LG may be a linking group including a hydrogen-bonding functional group,

L² and L³ may each independently be a substituted or unsubstituted C1 to C20 alkylene group, a substituted or unsubstituted C6 to C20 arylene group, a substituted or unsubstituted C1 to C20 oxyalkylene group, or a combination thereof, and

p1 and p2 may each independently be 0 or an integer of 1 to 10.

According to another aspect, there is provided a display device including the above-described films.

According to another aspect, there is provided an article coated with the above-described compositions.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram illustrating an effect that occurs after a composition according to an embodiment is coated on a substrate;

FIG. 2 is a cross-sectional view of a display device according to an embodiment; and

FIG. 3 is a cross-sectional view of a display device according to an embodiment.

### DETAILED DESCRIPTION

Reference will now be made in detail to embodiments, examples of which are illustrated in the accompanying drawings so that a person skilled in the art would understand the same, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. However, this disclosure may be embodied in many different forms, should not be construed as being limited to the embodiments set forth herein, and should be construed as including all modifications, equivalents, and alternatives within the scope of the present disclosure; rather, these embodiments are provided so that this disclosure will be thorough and complete, and will fully convey the effects and features of the disclosure and ways to implement the disclosure to those skilled in the art.

In the drawings, the thickness of layers, films, panels, regions, etc., are exaggerated for clarity. Like reference numerals designate like elements throughout the specification. The terminology used herein is for the purpose of describing particular embodiments only and is not intended to be limiting. As used herein, the singular forms “a,” “an,” and “the” are intended to include the plural forms, including “at least one,” unless the content clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. As used herein, the term “and/or” includes any and all combinations of one or more of the associated listed items. “Or” means “and/or.” Expressions such as “at least one of,” when preceding a list of elements, modify the entire list of elements and do not modify the individual elements of the list. “At least one” and “one or more” is not to be construed as limiting “a” or “an.”

It will be understood that when an element such as a layer, film, region, or substrate is referred to as being “on” another element, it can be directly on the other element or intervening elements may also be present. In contrast, when an element is referred to as being “directly on” another element, there are no intervening elements present.

About” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±10% or ±5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Hereinafter, embodiments of a silane compound including a fluorine-containing poly(ether) group, a composition including the same, a film formed from the composition, a stack structure, a preparing method thereof, a display device, and an article will be described in greater detail.

According to an aspect, there is provided a silane compound including a fluorine-containing poly(ether) group, the silane compound being represented by Formula 1.

Rf-(L¹)ₚ₁-Q1-(L²)ₚ₂-Si(R₁)(R₂)-(L³)ₚ₃-Si(R₃)(R₄)(R₅) Formula 1

### In Formula 1,

Rf indicates a fluorine-containing poly(ether) group,

Q1 may be —O—, —C(═O)O—, —O—C(═O)O—, —NR^{a}C(═O)O—, —C(═O)NR^{b}—, —OC(═O)NR^{c}S(═O)O—, or —CH₂(C₆H₄)C(═O)—, wherein R^{a} to R^{c} may each independently be hydrogen, a substituted or unsubstituted C1 to C20 alkyl group, a substituted or unsubstituted C6 to C20 aryl group, or a combination thereof,

L¹ and L³ may each independently be a substituted or unsubstituted C1 to C20 alkylene group, a substituted or unsubstituted C1 to C20 oxyalkylene group, or a combination thereof,

L² may be a substituted or unsubstituted C1 to C20 alkylene group, a substituted or unsubstituted C1 to C20 oxyalkylene group, —(CH₂)ₘ—NH—(CH₂)ₙ— (where m and n may each independently be an integer of 1 to 10), or a combination thereof,

p1 to p3 may each independently be an integer of 1 to 10,

R₁ to R₅ may each independently be hydrogen, a substituted or unsubstituted C1 to C20 alkoxy group, a halogen atom, a hydroxyl group, a substituted or unsubstituted C1 to C20 alkyl group, a substituted or unsubstituted C6 to C20 aryl group, or a combination thereof,

wherein at least one of R₁ to R₅ may be a substituted or unsubstituted C1 to C20 alkoxy group, a halogen atom, or a hydroxyl group, or at least one of R₃ to R₅ may be -(L⁴)ₚ₄-Si(R₉)(R₁₀)(R₁₁), or -(L⁴)ₚ₄-Si(R₁₂)(R₁₃)-(L⁵)ₚ₅-Si(R₉)(R₁₀)(R₁₁), and each of the other R₃ to R₅ may be a substituted or unsubstituted C1 to C20 alkoxy group, a halogen atom, or a hydroxyl group,

R₁₁ to R₁₃ may each independently be hydrogen, a substituted or unsubstituted C1 to C20 alkoxy group, a halogen atom, a hydroxyl group, a substituted or unsubstituted C1 to C20 alkyl group, a substituted or unsubstituted C6 to C20 aryl group, or a combination thereof, wherein, when R₃ to R₅ are each -(L⁴)ₚ₄-Si(R₉)(R₁₀)(R₁₁), or -(L⁴)ₚ₄-Si(R₁₂)(R₁₃)-(L⁵)ₚ₅-Si(R₉)(R₁₀)(R₁₁), at least one of R₁₁ to R₁₃ may be a substituted or unsubstituted C1 to C20 alkoxy group, a halogen atom or a hydroxyl group, L⁴ and L⁵ may each independently be a substituted or unsubstituted C1 to C20 alkylene group, a substituted or unsubstituted C1 to C20 oxyalkylene group, or a combination thereof, and

p4 and p5 may each independently be an inter of 1 to 10.

In the definition of Rf, a fluorine-containing poly(ether) group may refer to a fluorine-containing ether group or fluorine-containing poly(ether) group.

According to another aspect, there is provided a composition including the above-described silane compound including a fluorine-containing poly(ether) group.

The composition including the fluorine-containing silane compound may be used as a surface coating material. When the composition is used to form a surface coating film on an upper portion of a display, the surface coating film may be worn down over time and have reduced durability.

To address the above problems, the inventors have developed a composition including a silane compound represented by Formula 1, having a fluorine-containing poly(ether) group. The silane compound being represented by Formula 1, may maintain good slipperiness and may increase bonding between the silane compounds including fluorine-containing poly(ether) groups, thereby improving wear resistance and durability.

The silane compound including a fluorine-containing poly(ether) group, as represented by Formula 1, may include more hydrolyzable silane groups than a fluorine-containing silane compound according to the prior art, and thus may increase bonding between the silane compounds including fluorine-containing poly(ether) groups.

The composition may further include an additive which is able to interact with the silane compound including a fluorine-containing poly(ether) group, i.e., the silane compound being represented by Formula 1. When the composition further includes such an additive as described above, durability may be further improved.

When the composition according to one or more embodiments, including the silane compound including a fluorine-containing poly(ether) group as described above, is coated on a surface of a touch screen panel provided on a portable terminal, or a surface of a display device such as a liquid display device (LCD) or a plasma display panel (PDP) to form a film, the film may provide improved water repellency, fingerprint resistance, wear resistance and durability.

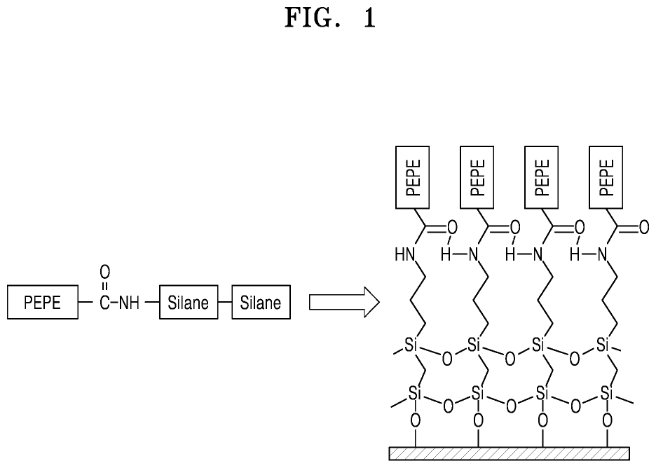

FIG. 1 is a diagram illustrating a structure of a composition according to an embodiment which includes the silane compound including a fluorine-containing poly(ether) group when the composition forms a film by being coated on a surface of a substrate.

As illustrated in FIG. 1, the silane compound including a fluorine-containing poly(ether) group (PEPE) may be linked to a hydrolyzable silane group (denoted as “Silane” in FIG. 1) by amide bonds. In some embodiments, the fluorine-containing poly(ether) group (PEPE) may have a structure containing a perfluoroether end group linked to a poly(ether) group, i.e., a perfluoroetherpoly(ether) (PFPE) group.

The hydrolyzable silane group may be a silane substituted with at least one hydrolyzable functional group, for example, a silane substituted with at least one substituted or unsubstituted C1 to C20 alkoxy group, a halogen atom, or a hydroxyl group. The hydrolyzable silane group may be bonded to the substrate or an underlying film by hydrolysis and/or condensation polymerization during coating or deposition.

Since the hydrolyzable silane group has a hydrolyzable functional group, through hydrolysis and condensation polymerization of the hydrolyzable silane group in a coating process of the composition, a network of the products of hydrolysis and polymerization condensation of silane is formed as shown in FIG. 1.

According to one or more embodiments, since the silane compound including a fluorine-containing poly(ether) group, represented by Formula 1, includes at least two silane groups, the bonding between the silane compounds may be stronger, as compared with a compound containing one silane group, and a film formed from the silane compound of Formula 1 may have further improved wear resistance. In addition, since a hydrogen bond is formed between amide bonds as shown in FIG. 1, the bonding between the silane compounds may become further stronger.

The hydrolyzable functional group may be, for example, a C1-C10 alkoxy group, a halogen atom, or a hydroxyl group. For example, the hydrolyzable functional group may be a C1-C8 alkoxy group, for example, a methoxy group or an ethoxy group. Of these functional groups, the methoxy group shows excellent hydrolysis reactivity.

In one or more embodiment, in the silane compound including a fluorine-containing poly(ether) group, represented by Formula 1, the fluorine-containing poly(ether) group, Rf, may be perfluoroether or perfluoropoly(ether).

For example, the fluorine-containing poly(ether) group (Rf) may have i) a structure having a CF₃O group, a CF₃CF₂O group, or a CF₃CF₂CF₂O group at a terminal thereof, wherein —(CF₂CF₂O)ₙ— and —(CF₂O)ₘ— (wherein m and n may each independently be an integer of 1 to 100) are bonded in any order to the CF₃O group, the CF₃CF₂O group or the CF₃CF₂CF₂O group, or ii) a structure having a CF₃O group, a CF₃CF₂O group, or a CF₃CF₂CF₂O group at a terminal thereof, wherein —(CF₂CF₂O)ₙ—, —(CF₂O)ₘ—, —(CF₂CF₂CF₂O)ₙ—, —(CF₂CF₂CF₂CF₂O)ₙ— and —(CF₂CF₂F₂CF₂CF₂O)ₙ— (wherein m and n may each independently be an integer of 1 to 100) are bonded in any order to the CF₃O group, the CF₃CF₂O group or the CF₃CF₂CF₂O group. Here, the term “order” may refer to the order in which, for example, —(CF₂CF₂O)ₙ— and —(CF₂)ₘ— are bonded to a CF₃O group, a CF₃CF₂O group, or a CF₃CF₂CF₂O group, and m and n may each independently be, for example, an integer of 1 to 60, an integer of 5 to 55, an integer of 10 to 50, or an integer of 15 to 40.

The fluorine-containing poly(ether) group (Rf) may be a perfluoropoly(ether) such as, for example,

CF₃O—(CF₂CF₂O)ₙ—(CF₂O)ₘ—,

CF₃O—(CF₂O)ₘ—(CF₂CF₂O)ₙ,

CF₃CF₂O—(CF₂CF₂O)ₙ—(CF₂O)ₘ—,

CF₃CF₂O—(CF₂O)ₘ—(CF₂CF₂O)ₙ—,

CF₃CF₂CF₂O—(CF₂CF₂O)ₙ—(CF₂O)ₘ—, or

CF₃CF₂CF₂O—(CF₂O)ₘ—(CF₂CF₂O)ₙ—,

wherein m and n may each independently be, for example, an integer of 1 to 100, an integer of 1 to 60, an integer of 5 to 55, an integer of 10 to 50, or an integer of 15 to 40. The fluorine-containing poly(ether) group (Rf) may be a perfluoropoly(ether) such as, for example,

CF₃O—(CF₂CF₂O)ₙ—(CF₂O)ₘ—(CF₂CF₂CF₂O)ₙ—,

CF₃O—(CF₂O)ₘ—(CF₂CF₂O)ₙ—(CF₂CF₂CF₂O)ₙ—,

CF₃O—(CF₂CF₂O)ₙ—(CF₂O)ₘ—(CF₂CF₂CF₂CF₂O)ₙ—(CF₂CF₂CF₂O)ₙ—,

CF₃O—(CF₂O)ₘ—(CF₂CF₂O)ₙ—(CF₂O)ₘ—(CF₂CF₂CF₂CF₂O)ₙ—(CF₂CF₂CF₂O)ₙ—CF₃CF₂O—(CF₂CF₂O)ₙ—(CF₂O)ₘ—(CF₂CF₂CF₂O)ₙ—,

CF₃CF₂O—(CF₂O)ₘ—(CF₂CF₂O)ₙ—(CF₂CF₂CF₂O)ₙ—,

CF₃CF₂O—(CF₂CF₂O)ₙ—(CF₂O)ₘ—(CF₂CF₂CF₂CF₂O)ₙ—(CF₂CF₂CF₂O)ₙ—,

CF₃CF₂O—(CF₂O)ₘ—(CF₂CF₂O)ₙ—(CF₂O)ₘ—(CF₂CF₂CF₂CF₂O)ₙ—(CF₂CF₂CF₂O)ₙ—,

CF₃CF₂CF₂O—(CF₂CF₂O)ₙ—(CF₂O)ₘ—(CF₂CF₂CF₂O)ₙ—,

CF₃CF₂CF₂O—(CF₂O)ₘ—(CF₂CF₂O)ₙ—(CF₂CF₂CF₂O)ₙ—,

CF₃CF₂CF₂O—(CF₂CF₂O)ₙ—(CF₂O)ₘ—(CF₂CF₂CF₂CF₂O)ₙ—(CF₂CF₂CF₂O)ₙ—, or

CF₃CF₂CF₂O—(CF₂O)ₘ—(CF₂CF₂O)ₙ—(CF₂O)ₘ—(CF₂CF₂CF₂CF₂O)ₙ—(CF₂CF₂CF₂O)ₙ—,

wherein m and n may each independently be, for example, an integer of 1 to 100, an integer of 1 to 60, an integer of 5 to 55, an integer of 10 to 50, or an integer of 15 to 40.

In Formula 1, Rf may be CF₃O(CF₂CF₂O)ₙ(CF₂O)ₘCF₂—, and n and m may each independently be, for example, an integer of 1 to 100, an integer of 1 to 60, an integer of 5 to 55, an integer of 10 to 50, or an integer of 15 to 40.

The silane compound including a fluorine-containing poly(ether) group, represented by Formula 1, may be, for example,

CF₃O(CF₂CF₂O)ₙ(CF₂O)ₘ—(CR₁₄R₁₅)ₚ₁—C(═O)NH—(CH₂)ₚ₂—NH—(CH₂)ₚ₃—Si(R₁)(R₂)—(CH₂)ₚ₄— Si(R₃)(R₄)(R₅), or

CF₃O(CF₂CF₂O)ₙ(CF₂O)ₘ—(CR₁₄R₁₅OCR₁₆R₁₇)ₚ₁—C(═O)NH—(CH₂)ₚ₂—NH—(CH₂)ₚ₃—Si(R₁)(R₂)—(CH₂)ₚ₄—Si(R₃)(R₄)(R₅),

wherein n and m may each independently be an integer of 1 to 100, an integer of 1 to 50, an integer of 1 to 30, an integer of 1 to 20, an integer or 1 to 10, or an integer of 1 to 5; R₁₄ to R₁₅ may each independently be hydrogen, C1-C5 alkyl, fluorine, or fluorinated C1-C5 alkyl group; p1 to p4 may each independently be an integer of 1 to 10, an integer of 1 to 8, an integer of 1 to 6, or an integer of 1 to 4; R₁ to R₅ may each independently be hydrogen, a substituted or unsubstituted C1 to C20 alkoxy group, a halogen atom, a hydroxyl group, a substituted or unsubstituted C1 to C20 alkyl group, a substituted or unsubstituted C6 to C20 aryl group, or a combination thereof, wherein at least one of R₁ to R₅ may be a C1 to C20 alkoxy group, a halogen atom, or a hydroxyl group. For example, p1 to p3 may each independently be an integer of 1 to 10, an integer of 1 to 5, an integer of 1 to 3, or an integer of 1 to 2.

For example, the silane compound including a fluorine-containing poly(ether) group may be

CF₃O(CF₂CF₂O)ₙ(CF₂O)ₘ—CH₂—O—CH₂—C(═O)NH—(CH₂)₂—NH—(CH₂)₃—Si(OCH₃)(OCH₃)—CH₂—Si(OCH₃)(OCH₃)(OCH₃),

CF₃O(CF₂CF₂O)ₙ(CF₂O)ₘ—(CH₂)₂—C(═O)NH—(CH₂)₂—NH—(CH₂)₃—Si(OCH₃)(OCH₃)—CH₂—Si(OCH₃)(OCH₃)(OCH₃),

CF₃O(CF₂CF₂O)ₙ(CF₂O)ₘ—(CF₂)₂—C(═O)NH—(CH₂)₂—NH—(CH₂)₃—Si(OCH₃)(OCH₃)—CH₂—Si(OCH₃)(OCH₃)(OCH₃),

CF₃O(CF₂CF₂O)ₙ(CF₂O)ₘ—(CH₂)₂—C(═O)NH—(CH₂)₂—NH—(CH₂)₃—Si(OCH₃)(OCH₃)—CH₂—Si(OCH₃)(OCH₃)(CH₃),

CF₃O(CF₂CF₂O)ₙ(CF₂O)ₘ—(CF₂)₂—C(═O)NH—(CH₂)₂—NH—(CH₂)₃—Si(OCH₃)(OCH₃)—CH₂—Si(OCH₃)(OCH₃)(CH₃),

CF₃CF₂O(CF₂CF₂O)ₙ(CF₂O)ₘ—(CH₂)₂—C(═O)NH—(CH₂)₂—NH—(CH₂)₃—Si(OCH₃)(OCH₃)—CH₂—Si(OCH₃)(OCH₃)(OCH₃),

CF₃CF₂O(CF₂CF₂O)ₙ(CF₂O)ₘ—(CF₂)₂—C(═O)NH—(CH₂)₂—NH—(CH₂)₃—Si(OCH₃)(OC H₃)—CH₂—Si(OCH₃)(OCH₃)(OCH₃),

CF₃CF₂O(CF₂CF₂O)ₙ(CF₂O)ₘ—(CH₂)₂—C(═O)NH—(CH₂)₂—NH—(CH₂)₃—Si(OCH₃)(OCH₃)—CH₂—Si(OCH₃)(OCH₃)(CH₃),

CF₃CF₂O(CF₂CF₂O)ₙ(CF₂O)ₘ—(CF₂)₂—C(═O)NH—(CH₂)₂—NH—(CH₂)₃—Si(OCH₃)(OCH₃)—CH₂Si(OCH₃)(OCH₃)(CH₃),

CF₃CF₂CF₂O(CF₂CF₂O)ₙ(CF₂)ₘ—(CH₂)₂—C(═O)NH—(CH₂)₂—NH—(CH₂)₃—Si(OCH₃)(OCH₃)—CH₂—Si(OCH₃)(OCH₃)(OCH₃),

CF₃CF₂CF₂O(CF₂CF₂O)ₙ(CF₂O)ₘ—(CF₂)₂—C(═O)NH—(CH₂)₂—NH—(CH₂)₃—Si(OCH₃)(OCH₃)—CH₂—Si(OCH₃)(OCH₃)(OCH₃),

CF₃CF₂CF₂O(CF₂CF₂O)ₙ(CF₂O)ₘ—(CH₂)₂—C(═O)NH—(CH₂)₂—NH—(CH₂)₃—Si(OCH₃)(OCH₃)—CH₂—Si(OCH₃)(OCH₃)(CH₃), or

CF₃CF₂—CF₂O(CF₂CF₂O)ₙ(CF₂O)ₘ—(CF₂)₂—C(═O)NH—(CH₂)₂—NH—(CH₂)₃—Si(OCH₃)(OCH₃)CH₂Si(OCH₃)(OCH₃)(CH₃).

In one or more embodiments, the composition may include, as an additive, a compound represented by Formula 2, a compound represented by Formula 3, or a combination thereof.

H₂N-(L²)ₚ₂-Si(R₁)(R₂)-(L³)ₚ₃-Si(R₃)(R₄)(R₅) Formula 2

### In Formula 2,

L² may be a substituted or unsubstituted C1 to C20 alkylene group, a substituted or unsubstituted C1 to C20 oxyalkylene group, —(CH₂)ₘ—NH—(CH₂)ₙ— (wherein m and n may each independently be an integer of 1 to 10), or a combination thereof,

L³ may be a substituted or unsubstituted C1 to C20 alkylene group, a substituted or unsubstituted C1 to C20 oxyalkylene group, or a combination thereof,

p2 and p3 may each independently be an integer of 1 to 10,

R₁ to R₅ may each independently be hydrogen, a substituted or unsubstituted C1 to C20 alkoxy group, a halogen atom, a hydroxyl group, a substituted or unsubstituted C1 to C20 alkyl group, a substituted or unsubstituted C6 to C20 aryl group, or a combination thereof, wherein at least one of R₁ to R₅ may be a substituted or unsubstituted C1 to C20 alkoxy group, a halogen atom, or a hydroxyl group, or at least one of R₃ to R₅ may be

-(L⁴)ₚ₄-Si(R₉)(R₁₀)(R₁₁) or

-(L⁴)ₚ₄-Si(R₁₂)(R₁₃)-(L⁵)ₚ₅-Si(R₉)(R₁₀)(R₁₁),

and each of the other R₃ to R₅ may be a substituted or unsubstituted C1 to C20 alkoxy group, a halogen atom, or a hydroxyl group,

R₉ to R₁₃ may each independently be hydrogen, a substituted or unsubstituted C1 to C20 alkoxy group, a halogen atom, a hydroxyl group, a substituted or unsubstituted C1 to C20 alkyl group, a substituted or unsubstituted C6 to C20 aryl group, or a combination thereof, wherein at least one of R₉ to R₁₃ may be a substituted or unsubstituted C1 to C20 alkoxy group, a halogen atom, or a hydroxyl group,

L⁴ and L⁵ may each independently be a substituted or unsubstituted C1 to C20 alkylene group, a substituted or unsubstituted C1 to C20 oxyalkylene group, or a combination thereof, and

p4 and p5 may each independently be an integer of 1 to 10.

A-L⁶-Si(R₅)(R₆)(R₇) Formula 3

### In Formula 3,

L⁶ may be a substituted or unsubstituted C1 to C20 alkylene group, a substituted or unsubstituted C6 to C20 arylene group, or a combination thereof,

R₅ to R₇ may each independently be hydrogen, a substituted or unsubstituted C1 to C20 alkoxy group, a halogen atom, a hydroxyl group, a substituted or unsubstituted C1 to C20 alkyl group, a substituted or unsubstituted C6 to C20 aryl group, or a combination thereof, and

A may be a halogen, a thiol group, an isocyanate group, or an amino group, and

wherein at least one of R₅ to R₇ may be a substituted or unsubstituted C1 to C20 alkoxy group, a halogen atom, or a hydroxyl group.

The compound of Formula 3 may be, for example, a compound of Formula 3A.

H₂N-L⁶-Si(R₅)(R₆)(R₇) Formula 3A

### In Formula 3A,

L⁶, and R₅ to R₇ may be defined as those in Formula 3.

As an additive, the compound represented by Formula 2, the compound represented by Formula 3 or a combination thereof may enable non-covalent interaction with the silane compound including a fluorine-containing poly(ether) group. While not wanting to be bound by theory, it is understood that, the compound represented by Formula 2 and the compound represented by Formula 3 may each enable, due to an amino group thereof, non-covalent interaction between the additive and the silane compound including a fluorine-containing poly(ether) group. As unshared electron pairs of the amino group undergo non-covalent interactions such as hydrogen bond with hydrogen atoms of amide groups which constitute an amide linking group in the silane compound including a fluorine-containing poly(ether) group, a substrate coated with the composition according to one or more embodiments may have improved durability.

When the composition further includes a compound of Formula 2, a mixed molar ratio of the silane compound including a fluorine-containing poly(ether) group, the silane compound being represented by Formula 1, to the compound of Formula 2 may be about 1:0.003 to about 1:3, for example, about 1:0.5 to about 1:3, or about 1:1 to about 1:2.

The compound represented by Formula 2 may be, for example, H₂N—(CH₂)ₚ₂—NH—(CH₂)ₚ₃—Si(R₁)(R₂)—(CH₂)ₚ₄—Si(R₃)(R₄)(R₅),

wherein R₁ to R₅ may each independently a hydrogen, a substituted or unsubstituted C1 to C20 alkoxy group, a halogen atom, a hydroxyl group, a substituted or unsubstituted C1 to C20 alkyl group, or a combination thereof, at least one of R₁ to R₅ may be a C1-C20 alkoxy group, a halogen atom, or a hydroxyl group, and

p2 to p4 may each independently be an integer of 1 to 10.

The compound represented by Formula 2 may be, for example,

H₂N—(CH₂)₂—NH—(CH₂)₃—Si(OCH₃)(OCH₃)—CH₂—Si(OCH₃)(OCH₃)(OCH₃),

H₂N—(CH₂)₂—NH—(CH₂)₃—Si(OCH₂CH₃)(OCH₂CH₃)—CH₂—Si(OCH₂CH₃)(OCH₂CH₃)(OCH₂CH₃),

H₂N—(CH₂)₂—NH—(CH₂)₃—Si(OCH₃)(OCH₃)—(CH₂)₂—Si(OCH₃)(OCH₃)(OCH₃),

H₂N—(CH₂)₂—NH—(CH₂)₃—Si(OCH₂CH₃)(OCH₂CH₃)—(CH₂)₂—Si(OCH₂CH₃)(OCH₂CH₃) (OCH₂CH₃),

H₂N—(CH₂)₂—NH—(CH₂)₃—Si(OCH₃)(OCH₃)—(CH₂)₃Si(OCH₃)(OCH₃)(OCH₃),

H₂N—(CH₂)₂—NH—(CH₂)₃—Si(OCH₂CH₃)(OCH₂CH₃)—(CH₂)₃—Si(OCH₂CH₃)(OCH₂CH₃) (OCH₂CH₃),

H₂N—(CH₂)₂—NH—(CH₂)₂—Si(OCH₃)(OCH₃)—CH₂—Si(OCH₃)(OCH₃)(OCH₃),

H₂N—(CH₂)₂—NH—(CH₂)₂—Si(OCH₂CH₃)(OCH₂CH₃)—CH₂—Si(OCH₂CH₃)(OCH₂CH₃)(OCH₂CH₃),

H₂N—(CH₂)₂—NH—(CH₂)₃—Si(OCH₃)(OCH₃)—CH₂—Si(OCH₃)(OCH₃)(CH₃), or

H₂N—(CH₂)₂—NH—(CH₂)₃—Si(OCH₂CH₃)(CH₂CH₃)—CH₂—Si(OCH₂CH₃)(OCH₂CH₃)(CH₂CH₃).

When the composition further includes a compound of Formula 3, a mixed molar ratio of the silane compound including a fluorine-containing poly(ether) group, represented by Formula 1, to the compound of Formula 3 may be about 1:0.003 to about 1:3, for example, about 1:0.5 to about 1:3, or about 1:1 to about 1:2.

The compound represented by Formula 3 may be, for example,

H₂N—(CH₂)₃—Si(OCH₃)(OCH₃)(OCH₃),

H₂N—(CH₂)₃—Si(OCH₂CH₃)(OCH₂CH₃)(OCH₂CH₃),

H₂N—(CH₂)₃—Si(OCH₃)(OCH₃)(CH₃), or

H₂N—(CH₂)₃—Si(OCH₂CH₃)(OCH₂CH₃)(CH₂CH₃).

In the silane compound being represented by Formula 1, the fluorine-containing poly(ether) group Rf may be a fluorine-containing poly(ether) group. For example, the fluorine-containing poly(ether) group may have a weight average molecular weight of about 1,000 grams per mole (g/mol) to about 10,000 g/mol, for example, about 2,000 to about 9,000 g/mol, or about 3,000 to about 6,000 g/mol.

According to another aspect, there is provided a composition including the compound represented by Formula 2. The composition may further include a compound of Formula 4.

FpE-(L²)ₚ₁-LG-(L³)ₚ₂-SiR^{a}R^{b}R^{c} Formula 4

In Formula 4,

FpE may be a fluorine-containing poly(ether) moiety;

R^{a}, R^{b} and R^{c} may each independently be hydrogen, a substituted or unsubstituted C1 to C20 alkoxy group, a halogen, a hydroxyl group, a substituted or unsubstituted C1 to C20 alkyl group, a substituted or unsubstituted C6 to C20 aryl group, or a combination thereof, wherein at least one of R^{a}, R^{b} and R^{c} may be a substituted or unsubstituted C1 to C20 alkoxy group, a halogen, or a hydroxyl group;

LG may be a linking group including a hydrogen-bonding functional group;

L² and L³ may each independently be a substituted or unsubstituted C1 to C20 alkylene group, a substituted or unsubstituted C6 to C20 arylene group, a substituted or unsubstituted C1 to C20 oxyalkylene group, or a combination thereof; and

p1 and p2 may each independently be 0 or an integer of 1 to 10.

In the composition according to one or more embodiments, a mixed molar ratio of the compound represented by Formula 2 to the compound represented by Formula 4 may be, for example, about 0.003:1 to about 3:1, or about 0.5:1 to about 3:1, or about 1:1 to about 2:1. A substrate coated with a surface coating agent including the composition having a mixed ratio as above may have improved durability.

The compound represented by Formula 4 may have a fluorine-containing poly(ether) group and a hydrolyzable silane group at the respective terminals thereof. As a result, due to a difference in surface energy between the terminals, the fluorine-containing compounds of Formula 4 may be arranged in one direction. The compound may include a fluorine-containing poly(ether) group at one terminal, a hydrolyzable silane group at the other terminal, and a linking group between the fluorine-containing poly(ether) group and the hydrolyzable silane group.

The fluorine-containing poly(ether) group may be, for example, poly(ether) having at least one fluorine, or may be, for example, perfluoro(poly)ether. The fluorine-containing poly(ether) group may be represented by, for example, CF₃O(CF₂CF₂O)ₙ(CF₂)ₘCF₂ (wherein n and m may each independently be an integer of 1 to 60). However, embodiments are not limited thereto.

The hydrolyzable silane group may be a silane substituted with at least one hydrolyzable functional group. For example, the hydrolyzable silane group may be a silane substituted with at least one substituted or unsubstituted C1 to C20 alkoxy group, a halogen, or a hydroxyl group. The hydrolyzable silane group may be bonded to a substrate or an underlying layer through hydrolysis and/or condensation polymerization reaction during coating or deposition.

The linking group may be located between the fluorine-containing poly(ether) group and the hydrolyzable silane group, and may form non-covalent interactions with adjacent molecules. The non-covalent interaction, which is as a non-covalent bond, may be, for example, a hydrogen bond.

The linking group (LG), which is able to form a hydrogen bond, may have heteroatoms (having an unshared electron pair), for example, nitrogen, oxygen, sulfur, or a combination thereof. For example —C(═O)NR^{d}—, —OC(═O)NR^{e}—, —OC(═O)NR^{f}S(═O)—, —OC(═O)NR^{g}S(═O)O—, or a combination thereof (wherein R^{d} to R^{g} may each independently be hydrogen, a substituted or unsubstituted C1 to C20 alkyl group, a substituted or unsubstituted C6 to C20 aryl group, or a combination thereof). However, embodiments are not limited thereto. For example, the linking group may be any linking group which is able to form a hydrogen bond.

For example, the fluorine-containing silane compound may have a linear structure. When the fluorine-containing silane compound has a branched structure (branch type) including a substituent group such as —CF₃, a substrate surface coated with a surface coating material including this compound may have reduced slipperiness, which can be less desirable in one or more embodiments.

For example, the fluorine-containing silane compound of Formula 4 may have a weight average molecular weight of about 4,000 g/mol to about 10,000 g/mol. When the fluorine-containing silane compound has a weight average molecular weight within this range, the surface coating material including this compound may have further improved durability.

For example, FpE may be perfluoro(poly)ether. For example, FpE may be a perfluoropoly(ether) represented by CF₃O(CF₂CF₂O)ₙ(CF₂)ₘCF₂ (wherein n and m may each independently be an integer of 1 to 100). For example, one of R^{a}, R^{b} and R^{c} may be a substituted or unsubstituted C1 to C20 alkoxy group, a halogen, or a hydroxyl group. For example, two of R^{a}, R^{b} and R^{c} may be a substituted or unsubstituted C1 to C20 alkoxy group, a halogen, or a hydroxyl group. For example, R^{a}, R^{b} and R^{c} may each independently be a substituted or unsubstituted C1 to C20 alkoxy group, a halogen, or a hydroxyl group.

In Formula 4, LG may be a hydrogen-bonding functional group, for example, —C(═O)NR^{d}—, —OC(═O)NR^{e}—, —OC(═O)NR^{f}S(═O)—, —OC(═O)NR^{g}S(═O)O— or a combination thereof (wherein R^{d} to R^{g} may each independently be hydrogen, a substituted or unsubstituted C1 to C20 alkyl group, a substituted or unsubstituted C6 to C20 aryl group, or a combination thereof.)

Further in Formula 4, L² and L³ may each independently be a substituted or unsubstituted methylene group, a substituted or unsubstituted ethylene group, a substituted or unsubstituted propylene group, a substituted or unsubstituted butylene group, a substituted or unsubstituted pentylene group, a substituted or unsubstituted hexylene group, a substituted or unsubstituted phenylene group, a substituted or unsubstituted biphenylene group, a substituted or unsubstituted naphthylene group, a substituted or unsubstituted oxymethylene group, a substituted or unsubstituted oxyethylene group, a substituted or unsubstituted oxypropylene group, or a combination thereof.

The fluorine-containing silane compound represented by Formula 4 may be represented by Formula 4A or Formula 4B.

CF₃O(CF₂CF₂)ₙ(CF₂)ₘCF₂—(C_{q}H_{2q}OC_{q}H_{2q})ₚ₁—IN—(CᵣH₂ᵣ)ₚ₂—SiR^{a}R^{b}R^{c} Formula 4A

CF₃O(CF₂CF₂)ₙ(CF₂)ₘCH₂—(C_{q}H_{2q}OC_{q}H_{2q})ₚ₁—IN—(CᵣH₂ᵣ)ₚ₂—SiR^{a}R^{b}R^{c} Formula 4B

### In Formula 4A and Formula 4B,

LG, R^{a}, R^{b}, R^{c}, n, m, p1, and p2 may be defined as those defined above, and q and r may each independently be an integer of 1 to 5.

For example, the fluorine-containing silane compound may be represented by Formula 4A-1 or Formula 4B-1.

CF₃O(CF₂CF₂O)ₙ(CF₂O)ₘCF₂—(C_{q}H_{2q}OC_{q}H_{2q})ₚ₁—C(═O)NH—(CᵣH₂ᵣ)ₚ₂—SiR^{a}R^{b}R^{c} Formula 4A-1

CF₃O(CF₂CF₂O)ₙ(CF₂O)ₘCH₂—(C_{q}H_{2q}OC_{q}H_{2q})ₚ₁—C(═O)NH—(CᵣH₂ᵣ)ₚ₂—SiR^{a}R^{b}R^{c}. Formula 4B-1

In Formula 4A-1 and Formula 4B-1, R^{a}, R^{b}, R^{c}, n, m, p1, p2, q, and r may be defined as above.

The composition according to one or more embodiments may include a plurality of fluorine-containing silane compounds having linking groups which are able to achieve non-covalent interaction with adjacent molecules between a fluorine-containing poly(ether) group and a hydrolyzable silane group, along with the silane compound represented by Formula 1, and thus may maintain strong inter-chain interactions between the adjacent molecular chains, and reduce or prevent bond damage and/or breakage of the plurality of fluorine-containing silane compounds caused by frequent friction. The plurality of fluorine-containing silane compounds may include compounds represented by Formula 1, Formula 4, Formula 4A, Formula 4A-1, Formula 4B, Formula 4B-1, or a combination thereof. Accordingly, the film by obtained by coating the composition may prevent easy wearing of the surface coating agent caused by frequent friction, and enhance durability.

According to another aspect, there is provided a film including the products of hydrolysis and condensation polymerization of the silane compound including a fluorine-containing poly(ether) group, the silane compound being represented by Formula 1.

As used herein, the expression “a product of hydrolysis and condensation polymerization of the silane compound including a fluorine-containing poly(ether) group” refers to one or more of the products of condensation polymerization of the products of hydrolysis of the silane compound including a fluorine-containing poly(ether) group.

The film may further include the compound of Formula 2, the compound of Formula 3, or a combination thereof. A mixed weight ratio of the products of hydrolysis and condensation polymerization of the silane compound including a fluorine-containing poly(ether) group, represented by Formula 1, to the compound of Formula 2, the compound of Formula 3, or a combination thereof may be, for example, about 1:0.5 to about 1:3, or about 1:1 to about 1:2.

According to another aspect, there is provided a film including

i) i-1) products of hydrolysis and condensation polymerization of the silane compound including the fluorine-containing poly(ether) group being represented by Formula 1, the silane compound represented by Formula 4, and i-2) the compound represented by Formula 2, or

ii) products of hydrolysis and condensation polymerization of a mixture of the silane compound including the fluorine-containing poly(ether) group being represented by Formula 1, the silane compound represented by Formula 4, and the compound represented by Formula 2.

In the film according to one or more embodiments, a mixed molar ratio of the products of hydrolysis and condensation polymerization of the silane compound represented by Formula 4, and the compound represented by Formula 2 may be, for example, about 1:0.003 to about 1:3, about 1:0.5 to about 1:3, or about 1:1 to about 1:2.

The film may be formed by coating the composition according to any of the embodiments using a solution process or by depositing the composition according to an embodiment using a dry process. Thus, the film may be a coating film or a deposition film. In an embodiment, a process of coating the surface coating material on a substrate, for example, a glass substrate (glass plate) may be provided. In particular, in connection with the process, the film may be obtained by coating a solution obtained by dissolving or dispersing the composition in a solvent by, for example, spin coating, slit coating, inkjet printing, spray coating, or dipping. The deposition film may be obtained by, for example, thermal deposition, vacuum deposition, or chemical vapor deposition.

The solvent may be, for example, a fluorinated ether-based solvent. The fluorinated ether-based solvent may be, for example,

1,1,2,2-tetrafluoroethyl-2,2,3,3-tetrafluoropropyl ether,

1,1,2,2-tetrafluoroethyl-1H,1H,5H-octafluoropentyl ether,

1,1,2,2-tetrafluoroethyl-2,2,2-trifluoroethyl ether, or a mixture thereof.

The film may be formed on a substrate. The substrate may be, for example, a ceramic or glass plate. However, embodiments are not limited thereto.

The film may include the products of hydrolysis and condensation polymerization of the silane compound including a fluorine-containing poly(ether) group, represented by Formula 1. The film may further include the compound represented by Formula 2, the compound represented by Formula 3, or a combination thereof. A mixed molar ratio of the products of hydrolysis and condensation polymerization of the silane compound including a fluorine-containing poly(ether) group represented by Formula 1, to the compound represented by Formula 2, the compound represented by Formula 3 or a combination thereof may be, for example, about 1:0.003 to about 1:3, about 1:0.5 to about 1:3, or about 1:1 to about 1:2.

In one or more embodiments, the film may include a product (i.e., one or more) products of hydrolysis and condensation polymerization of a mixture including i) the silane compound including a fluorine-containing poly(ether) group, represented by Formula 1, and ii) the compound represented by Formula 2, the compound represented by Formula 3 or a combination thereof. As such, the compound represented by Formula 2, the compound represented by Formula 3, or a combination thereof may participate in the hydrolysis and condensation polymerization reactions of the silane compound including a fluorine-containing poly(ether) group, represented by Formula 1, in a film formation process.

The film may have a structure in which a hydrolysable silane group of the silane compound including a fluorine-containing poly(ether) group is bound to a substrate, and the fluorine-containing poly(ether) group is arranged on a film surface (the air side). The plurality of silane compounds including a fluorine-containing poly(ether) group, may be arranged in substantially vertical direction.

The anti-fingerprint property of the film may be quantized by analyzing a contact angle of water of about 60° or higher and a contact angle of diiodomethane of about 45° or lower.

In one or more embodiments, the film may have a large contact angle due to the fluorine-containing poly(ether) group present on the surface thereof. Accordingly, the film may have good slippery and water-repellent properties. For example, the film may have a contact angle of about 100° or greater. The film may have a contact angle within this range, for example, a contact angle of about 105° or greater, about 110° or greater, or about 115° or greater, for example, a contact angle of about 100° to about 150°, about 100° to about 140°, about 100° to about 130°, about 110° to about 150°, about 110° to about 140°, about 110° to about 130°, about 115° to about 150°, about 115° to about 140°, or about 115° to about 130°. These contact angles are as measured by a sessile-drop technique. The liquid used in the contact angle measurement may be water. The contact angle may be measured after dropping a certain amount (˜3 microliters (μl)) of water onto the surface of the film, using a drop shape analyzer (DSA100, KRUSS, Germany).

The film may maintain a large contact angle even after frequent contact or rubbing. The durability of the film may be checked from a change in contact angle after being contacted or rubbed a plurality of times. For example, the film may have a contact in angle change by about 20° or smaller after an eraser abrasion test (100 times) with 1 kilogram (kg) load, for example, a change in contact angle by about 18° or smaller, about 15° or smaller, or about 12° or smaller, or about 10° or smaller. For example, the film may have a contact in angle change by about 20° to about 1°, about 18° to about 1°, about 15° to about 1°, about 12° to about 1°, or about 10° to about 1°. For example, the film may have a contact angle of about 100° or greater even after the eraser abrasion test with 1 kg load. For example, a contact angle of about 100° to about 150°, about 100° to about 140°, or about 100° to about 130° even after the eraser abrasion test with 1 kg load.

The contact angle of the film may be measured using diiodomethane, not water. In this case, the film may have a contact angle of, for example, about 90° or greater. The film may have a contact angle within this range, for example, about 95° or greater, or about 97° or greater, for example, a contact angle of about 90° to about 150°, about 95° to about 150°, or about 97° to about 150°. These contact angles are as measured by a sessile-drop technique. The liquid used in the contact angle measurement may be diiodomethane. The contact angle may be measured after dropping a certain amount (˜2.7 μl) of diiodomethane onto the surface of the film, using a drop shape analyzer (DSA100, KRUSS, Germany).

The film may form a stack structure with a substrate. The substrate may be, for example, a ceramic or glass substrate. The stack structure may further include at least one layer between the substrate and the film. The stack structure may be a transparent film, for example, a transparent flexible film.

For example, the film or stack structure may be attached onto a display panel. In this case, the display panel and the film or stack structure may be directly bound to each other or with an adhesive agent applied therebetween. The display panel may be, for example, a liquid crystal display panel or an organic light-emitting display panel. However, embodiments are not limited thereto. The film or stack structure may be arranged on a side of the display panel towards the viewer.

According to another aspect, there is provided a display device including a film including

i) products of hydrolysis and condensation polymerization of the silane compound including the fluorine-containing poly(ether) group being represented by Formula 1, or

a film including ii) ii-1) products of hydrolysis and condensation polymerization of the silane compound including the fluorine-containing poly(ether) group being represented by Formula 1, the silane compound represented by Formula 4, and ii-2) the compound represented by Formula 2.

Hereinafter, a method of manufacturing a stack structure according to an embodiment will be described.

First, a primer layer of SiO₂ may be formed on a surface of a substrate. Subsequently, the composition according to any of the embodiments may be coated on the primer layer.

The coating may be performed using a wet coating solution process or using a dry deposition process.

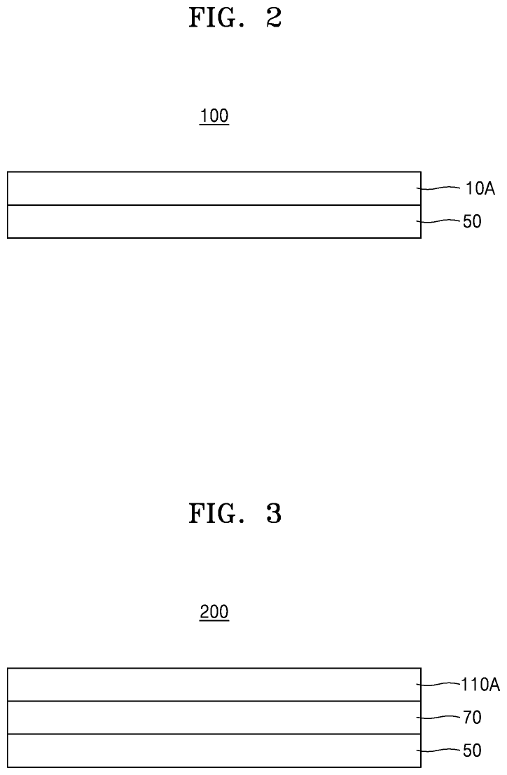

FIG. 2 is a cross-sectional view illustrating a display device according to an embodiment.

Referring to FIG. 2, a display device 100 according to an embodiment may include a display panel 50 and a functional film 10A.

The display panel 50 may be, for example, an organic light-emitting display panel or a liquid crystal display panel. The display panel 50 may be, for example, a bendable display panel, a foldable display panel, or a rollable display panel.

The functional film 10A may include the film or stack structure according to any of the above-described embodiments. The functional film 10A may be arranged on a viewer side. In addition, an additional layer may be interposed between the display panel 50 and the functional film 10A. For example, a polymer layer (not shown) as a single layer or multiple layers, and optionally, a transparent adhesive layer (not shown) may be further included.

FIG. 3 is a cross-sectional view of a display panel according to an embodiment.

Referring to FIG. 3, a display panel 200 according to an embodiment may include a display panel 50, a functional film 110A, and a touch screen panel 70 between the display panel 50 and the functional film 110A.

The display panel 50 may be, for example, an organic light-emitting display pane or a liquid crystal display pane. For example, the display panel 50 may be a bendable display panel, a foldable display panel, or a rollable display panel.

The functional film 110A may include the film or stack structure according to any of the above-described embodiments. The functional film 110A may be arranged on a viewer side.

The touch screen panel 70 may be arranged adjacent to the functional film 110A and the display panel 50. When touched with a human hand or an object through the functional film 110A, the touch screen panel 70 may recognize a touch position or location change, and output a touch signal. A driving module (not shown) may identify the position of the touch point from the touch signal and an icon displayed on the identified position of the touch point, and controls to perform a function corresponding to the identified icon, so that a result of performing the function may be displayed on the display panel 50.

An additional layer may be interposed between the touch screen panel 70 and the functional film 110A. For example, a polymer layer (not shown) as a single layer or multiple layers, and optionally a transparent adhesive layer (not shown) may be further included.

An additional layer may be interposed between the touch screen panel 70 and the display panel 50. For example, a polymer layer (not shown) as a single layer or multiple layers, and optionally a transparent adhesive layer (not shown) may be further included.

The functional film 110A including the film or stack structure according to any of the above-described embodiments may be applicable to various electronic devices, including a display device, for example, to a smart phone, a tablet PC, a camera, or a touch screen panel. However, embodiments are not limited thereto.

According to another aspect, there is provided an article obtained by coating the above-described surface coating agent on a substrate, for example, a glass substrate (glass plate). The article may be a mobile display device, a display for vehicles, a sensor, or an optical article. However, embodiments are not limited thereto.

Hereinafter, a method of preparing the silane compound including a fluorine-containing poly(ether) group, the silane compound being represented by Formula 1, will be described.

First, an ester compound having a fluorine-containing poly(ether) group, and a compound represented by Formula 2, a compound represented by Formula 3, or a combination thereof may be mixed together, and then allowed to react.

The reaction conditions may vary according to types of starting materials. For example, the reaction may be performed at, for example, about 25° C. to about 70° C., for example, about 25° C. to about 50° C. The reaction may be performed, for example, without a solvent.

The amount of the compound represented by Formula 2, the compound represented by Formula 3, or a combination thereof may be in a range of about 1 to about 2 moles with respect to 1 mole of the ester compound having a fluorine-containing poly(ether) group. When the amount of the compound represented by Formula 2, the compound represented by Formula 3 or a combination thereof is 2 moles, in additional to a reaction product, that is, the silane compound including a fluorine-containing poly(ether) group, the silane compound being represented by Formula 1, 1 mole of the compound represented by Formula 2, the compound represented by Formula 3 or a combination thereof may remain in a resulting product of the reaction. A solvent is added to the resulting product to prepare a film in situ.

Substituent groups in the formulae used herein are as defined below.

The term “alkyl” as used the formulae refers to a fully saturated branched or non-branched (e.g., straight or linear chain) hydrocarbon.

Non-limiting examples of the “alkyl” may include methyl, ethyl, n-propyl, isopropyl, n-butyl, isobutyl, sec-butyl, n-pentyl, isopentyl, neopentyl, n-hexyl, 3-methylhexyl, 2,2-dimethylpentyl, 2,3-dimethylpentyl, and n-heptyl.

At least one hydrogen atom of the “alkyl” may be substituted with a substituent selected from a halogen atom, a hydroxyl group, an alkoxy group, a nitro group, a cyano group, an amino group, an azido group, an amidino group, a hydrazino group, a hydrazono group, a carbonyl group, a carbamyl group, a thiol group, an ester group, a carboxyl group or a salt thereof, a sulfonic acid or a salt thereof, a phosphoric acid or a salt thereof, a C1 to C20 alkyl group, a C2 to C20 alkenyl group, a C2 to C20 alkynyl group, a C6 to C30 aryl group, a C7 to C30 aryl alkyl group, a C1 to C30 alkoxy group, a C1 to C20 heteroalkyl group, a C3 to C20 heteroaryl alkyl group, a C3 to C30 cycloalkyl group, a C3 to C15 cycloalkenyl group, a C6 to C15 cycloalkynyl group, a C3 to C30 heterocycloalkyl group, and a combination thereof.

The term “alkenyl” as used in the formulae refers to a linear or branched monovalent hydrocarbon group having one or more carbon-carbon double bonds. At least one hydrogen atom of the “alkenyl” may be substituted with a substituted as described above in connection with the alkyl group.

The term “alkynyl” as used in the formulae refers to a linear or branched monovalent hydrocarbon group having one or more carbon-carbon triple bonds. At least one hydrogen atom of the “alkynyl” may be substituted with a substituted as described above in connection with the alkyl group.

The term “aryl alkyl” and “heteroaryl alkyl” as used in the formulae refers to a substituted or unsubstituted aryl group or heteroaryl covalently linked to an alkyl group that is linked to a compound (e.g., a benzyl is a C7 aryl alkyl group). At least one hydrogen atom of the “aryl alkyl” or “heteroaryl alkyl” may be substituted with a substituted as described above in connection with the alkyl group.

The term “cycloalkyl” as used in the formulae refers to a monovalent hydrocarbon group having one or more saturated rings in which all ring members are carbon (e.g., cyclopentyl and cyclohexyl). At least one hydrogen atom of the “cycloalkyl” may be substituted with a substituted as described above in connection with the alkyl group.

The term “cycloalkenyl” as used in the formulae refers to a monovalent hydrocarbon group having one or more rings and one or more carbon-carbon double bond in the ring, wherein all ring members are carbon (e.g., cyclopentyl and cyclohexyl). At least one hydrogen atom of the “cycloalkenyl” may be substituted with a substituted as described above in connection with the alkyl group.

The term “cycloalkynyl” as used in the formulae refers to a stable aliphatic monocyclic or polycyclic group having at least one carbon-carbon triple bond, wherein all ring members are carbon (e.g., cyclohexynyl). At least one hydrogen atom of the “cycloalkynyl” may be substituted with a substituted as described above in connection with the alkyl group.

The term “heteroalkyl” as used in the formulae refers to an alkyl group that comprises at least one heteroatom covalently bonded to one or more carbon atoms of the alkyl group. At least one hydrogen atom of the “heteroalkyl” may be substituted with a substituted as described above in connection with the alkyl group.

The term “heteroaryl” as used in the formulae refers to an aromatic group that comprises at least one heteroatom covalently bonded to one or more carbon atoms of aromatic ring. At least one hydrogen atom of the “heteroaryl” may be substituted with a substituted as described above in connection with the alkyl group.

The term “halogen atom” as used in the formulae refers to fluoride, bromide, chloride, astatino, or iodo.

The term “alkoxy” as used in the formulae refers to alkyl-O—, and the term “alkyl” as used herein is as described above. Non-limiting examples of the alkoxy group may include methoxy, ethoxy, propoxy, 2-propoxy, butoxy, tert-butoxy, pentyloxy, hexyloxy, cyclopropoxy, and cyclohexyloxy. At least one hydrogen atom of the alkoxy group may be substituted with the same substituent groups as described in connection with the alkyl group.

The term “aryl” as used in the formulae may be used alone or in combination with other terms and refers to an aromatic hydrocarbon including at least one ring.

The term “aryl” may also refer to a group having an aromatic ring fused to at least one cycloalkyl ring. Non-limiting examples of the “aryl” may include phenyl, naphthyl, and tetrahydronaphthyl. At least one hydrogen atom of the “aryl” may be substituted with a substituted as described above in connection with the alkyl group.

As used herein, when a definition is not otherwise provided, “aromatic” refers to an organic compound or group comprising at least one unsaturated cyclic group having delocalized pi electrons. The term encompasses both hydrocarbon aromatic compounds and heteroaromatic compounds. At least one hydrogen atom of the “aromatic” may be substituted with a substituted as described above in connection with the alkyl group.

The term “alkylene” as used in the formulae refers to a substituted or unsubstituted bivalent saturated aliphatic alkylene (—CH₂—) covalently linked to an functional group on both the sides that is linked to a compound (e.g., an ethylene (—CH₂—CH₂—) is a C2 alkylene group, a propylene (—CH₂CH₂CH₂—) is a C3 alkylene group). At least one hydrogen atom of the “alkylene” may be substituted with a substituted as described above in connection with the alkyl group.

The term “oxyalkylene” as used in the formulae refers to a substituted or unsubstituted bivalent saturated aliphatic —O-alkylene or -alkylene-O— (e.g., an oxyethylene (—OCH₂CH₂—) is a C2 oxyalkylene group, a oxypropylene (—OCH₂CH₂CH₂—) is a C3 oxyalkylene group). At least one hydrogen atom of the “oxyalkylene” may be substituted with a substituted as described above in connection with the alkyl group.

The term “amino” as used in the formulae has the general formula —NRR, wherein each R is independently hydrogen, a C1-C12 alkyl group, a C7-C20 alkyl arylene group, a C7-C20 arylalkylene group, or a C6-C18 aryl group.

The term “arylene” as used in the formulae refers to a functional group having at least two valences obtained by removal of at least two hydrogens in at least one aromatic ring, and optionally substituted with at least one substituent as described above in connection with the alkyl group.

Throughout the specification, unless stated otherwise, the term “hetero” refers to containing 1 to 4 hetero atoms (N, O, S, Se, Te, Si, P, or a combination thereof).

One or more embodiments of the present disclosure will now be described in detail with reference to the following examples. However, these examples are only for illustrative purposes and are not intended to limit the scope of the one or more embodiments of the present disclosure.

### EXAMPLES

### Preparation of Silane Compound Including a Fluorine-Containing Poly(Ether) Group

### Preparation Example 1

1 equivalent of aminosilane compound (B) was added to 1 equivalent of perfluoropoly(ether) methyl ester (A) (molecular weight (Mw): 3202 g/mol), and then stirred at about 50° C. for about 16 hours. Novec-7200 (3M) was then added to the reaction mixture to obtain a composition containing about 20 weight percent (wt %) of compound (C).

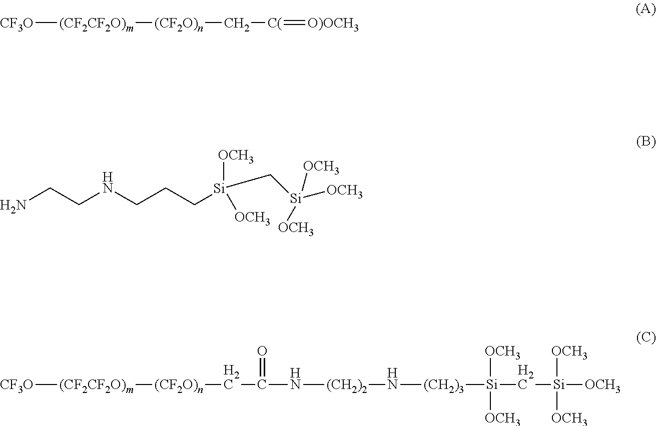

In compounds (A) and (C), m is 18 and n is 16.

The nuclear magnetic resonance (NMR) spectrum of compound (C) was measured by putting the composition containing compound (C) into an insert tube and adding Acetone-ds as an NMR solvent thereto. The results were as follows.

NMR Spectrum of Compound (C)

¹H-NMR (500 MHz, Acetone-d₆) δ (ppm): 0.02 (2H), 0.8 (2H), 1.7 (2H), 1.85 (2H), 2.74 (2H), 2.86 (2H), 3.45 (2H), 3.6 (6H), 3.8 (9H).

¹⁹F-NMR (470.4 MHz, Acetone-d₆) δ (ppm): −54.5˜−60.4 (42F), −83.1 (3F), −91.4˜−93.1 (92F), −128.4˜−132.1 (2F).

IR: Amide carbonyl peak identified at 1675 (cm⁻¹).

### Preparation Example 2

A compound was obtained in the same manner as in Preparation Example 1, except that perfluoropoly(ether) methyl ester (A) (Mw: 6000 g/mol) was used, instead of perfluoropoly(ether) methyl ester (A) (Mw: 3200 g/mol).

¹H-NMR (500 MHz, Acetone-d₆) δ (ppm): 0.02 (2H), 0.8 (2H), 1.7 (2H), 1.85 (2H), 2.74 (2H), 2.86 (2H), 3.45 (2H), 3.6 (6H), 3.8 (9H).

¹⁹F-NMR (470.4 MHz, Acetone-d₆) δ (ppm): −54.5˜−60.4 (66F), −83.0 (3F), −91.4˜−93.1 (138F), −128.3˜−132.1 (4F).

IR: Amide carbonyl peak identified at 1675 (cm⁻¹).

### Preparation Example 3

A silane compound including a fluorine-containing poly(ether) group (C1) was obtained in the same manner as in Preparation Example 1, except that perfluoropoly(ether) methyl ester (A) (Mw: 6000 g/mol) instead of perfluoropoly(ether) methyl ester (A) (Mw: 3200 g/mol), and aminosilane compound (B1) instead of aminosilane compound (B) were used.

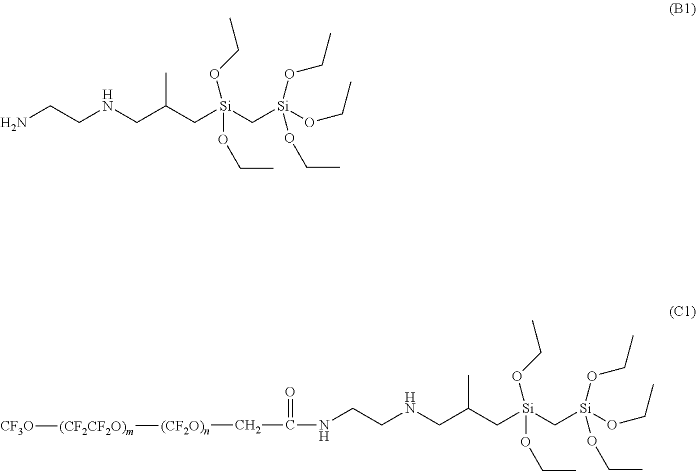

In compound (C1), m is 33, and n is 31.

¹H-NMR (500 MHz, Acetone-d₆) δ (ppm): 0.06 (2H), 0.65˜1.02 (2H), 1.13 (3H), 1.25 (15H), 2.01 (1H), 2.45 (2H), 2.53˜2.63 (2H), 2.75 (2H), 2.86 (2H), 3.9 (10H), 4.0 (2H).

¹⁹F-NMR (470.4 MHz, Acetone-d₆) δ (ppm): −54.5˜−60.4 (42F), −83.1 (3F), −91.4˜−93.1 (92F), −128.4˜−132.1 (2F).

IR: Amide carbonyl peak identified at 1675 (cm⁻¹).

### Preparation Example 4

A silane compound including a fluorine-containing poly(ether) group (C2) was obtained in the same manner as in Preparation Example 1, except that perfluoropoly(ether) methyl ester (A1), instead of perfluoropoly(ether) methyl ester (A), was used, and the reaction of perfluoropoly(ether) methyl ester and aminosilane compound (B) was performed at about 25° C.

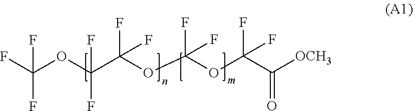

In Formula A1, m is 18, and n is 16.

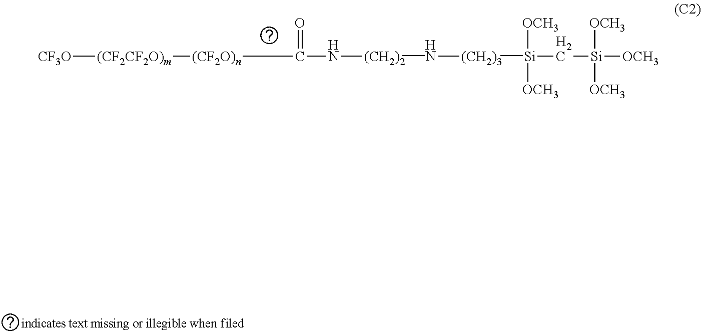

In compound (C2), m is 18, and n is 16.

¹H-NMR (500 MHz, Acetone-d₆) δ (ppm): 0.01 (2H), 0.84 (2H), 1.75 (2H), 2.75 (2H), 2.9 (41H), 3.47 (21H), 3.7 (9H).

¹⁹F-NMR (470.4 MHz, Acetone-d₆) δ (ppm): −54.5˜−60.4 (42F), −83.1 (3F), −91.4˜−93.1 (92F), −128.4˜−132.1 (2F).

IR: Amide carbonyl peak identified at 1729 (cm⁻¹).

### Preparation Example 5

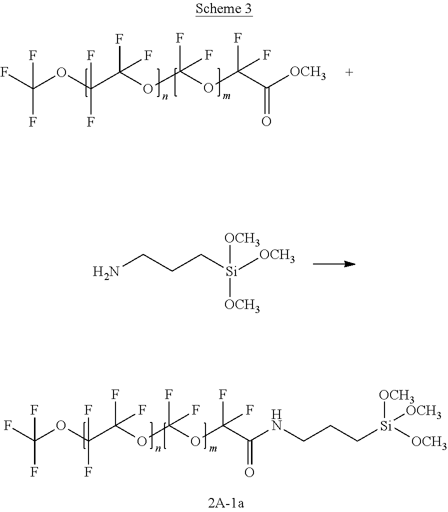

In Scheme 2, m is 18, and n is 16.

2 equivalents of 3-aminopropyl trimethoxysilane was added to 1 equivalent of perfluoro poly(ether) methyl ester CF₃O—(CF₂CF₂O)ₙ—(CF₂O)ₘ—CF₂—C(═O)OCH₃ (m is 18, and n is 16) (Mw: 50000 g/mol) was stirred at about 25° C. for about 5 hours. Then, after removing the unreacted reactants with a rotary pump, the resulting product was washed with Novec-7500 (3M) solvent and methanol. After removing the methanol layer, Novec 7500 was removed under vacuum conditions, to obtain a silane compound including a fluorine-containing poly(ether) group, the silane compound being represented by Formula 2A-1a.

¹H-NMR (500 MHz, Acetone-d₆) δ (ppm): 0.75 (2H), 1.8 (2H), 3.47 (2H), 3.67 (9H).

¹⁹F-NMR (470.4 MHz, Acetone-d₆) δ (ppm): −54.5˜−60.4 (42F), −83.1 (3F), −91.4˜−93.1 (92F), −128.4˜−132.1 (2F).

IR: Amide carbonyl peak identified at 1729 (cm⁻¹).

### Preparation Example 6

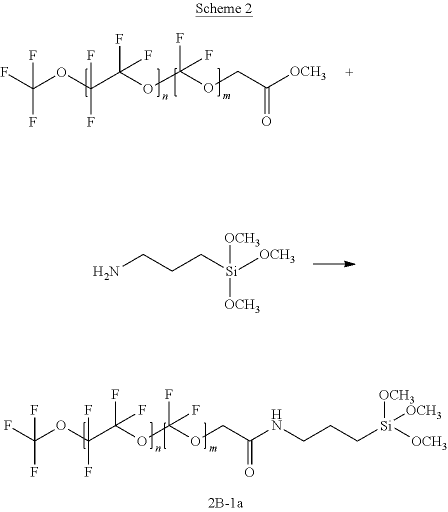

In Scheme 2, n is 18, and m 16.

1 equivalent of 3-aminopropyl trimethoxysilane was added to 1 equivalent of perfluoropolyether methyl ester (Mw: 3200 g/mol), and then stirred at about 50° C. for about 16 hours. Then, after removing the unreacted reactants with a rotatory rump, the resulting product was washed with Novec-7500 solvent and methanol. After removing the methanol layer, Novec 7500 was removed under vacuum conditions, to obtain a silane compound including a fluorine-containing poly(ether) group, the silane compound being represented by Formula 2B-1a.

NMR spectrum of compound 2B-1a

¹H-NMR (500 MHz, Acetone-d₆) δ (ppm): 0.7 (2H), 1.77 (2H), 3.47 (2H), 3.67 (9H), 4.01 (2H).

¹⁹F-NMR (470.4 MHz, Acetone-d₆) δ (ppm): −54.5˜−60.4 (42F), −83.1 (3F), −91.4˜−93.1 (92F), −128.4˜−132.1 (2F).

IR: Amide carbonyl peak identified at 1675 (cm⁻¹).

### Preparation Example 7

A silane compound including a fluorine-containing poly(ether) group, the silane compound being represented by Formula 2B-1a, was obtained in the same manner as in Preparation Example 6, except that perfluoropolyether methyl ester (Mw: 6000 g/mol), instead of perfluoropolyether methyl ester (Mw: 3200 g/mol), was used.

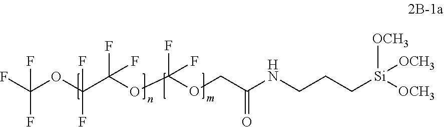

### Preparation of Composition and Film

### Example 1

The silane compound (C) including a fluorine-containing poly(ether) group, obtained in Preparation Example 1, and aminosilane compound (B) represented below were mixed in a molar ratio of about 1:1 in Novec-7200 solvent (available from 3M) to prepare a composition. A total amount of silane compound (C) and aminosilane compound (B) was about 20 parts by weight with respect to 100 parts by weight of the composition.

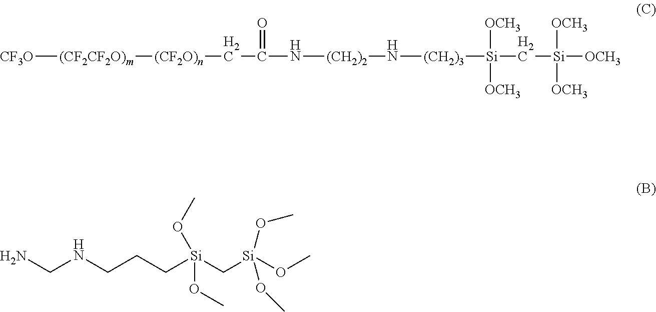

Next, the composition was coated on a glass substrate having a thermally deposited 7 nanometers (nm) thick SiO₂ layer by vacuum deposition (dry coating), to thereby form a film having a thickness of about 10 nm. In the vacuum deposition, the coated amount of the composition as a sample was about 0.15 grams per tablet (g/tablet).

### Example 2

A composition and a film were prepared in the same manner as in Example 1, except that the coated amount of the composition as a sample in vacuum deposition was varied to 0.18 g/tablet.

### Example 3

A composition and a film were prepared in the same manner as in Example 1, except that the silane compound including a fluorine-containing poly(ether) group, prepared in Preparation Example 2, was used, instead of the silane compound (C) including a fluorine-containing poly(ether) group, prepared in Preparation Example 1.

### Example 4

A composition and a film were prepared in the same manner as in Example 1, except that the silane compound (C) including a fluorine-containing poly(ether) group, prepared in Preparation Example 3, was used, instead of the silane compound (C) including a fluorine-containing poly(ether) group, prepared in Preparation Example 1 and except that aminosilane compound (B1) instead of the aminosilane compound (B) was used.

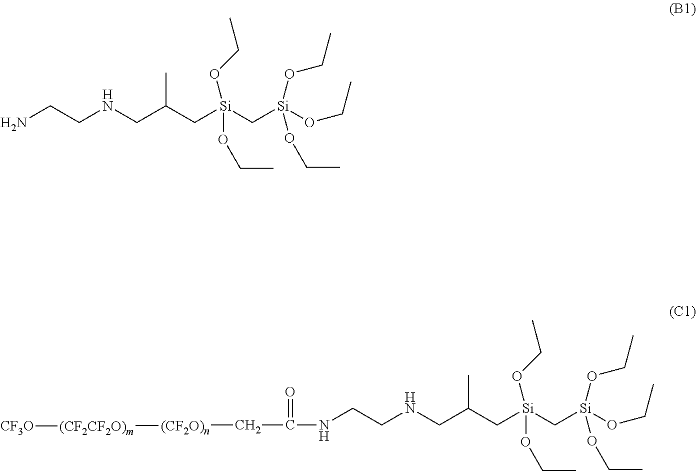

In compound (C), m is about 33, and n is about 31.

### Example 5

A composition and a film were prepared in the same manner as in Example 1, except that the silane compound (C) including a fluorine-containing poly(ether) group, prepared in Preparation Example 3, was used, instead of the silane compound (C) including a fluorine-containing poly(ether) group, prepared in Preparation Example 1, and silane compound (B1) instead of silane compound (B) was used, and the coated amount of the composition as a sample in vacuum deposition was varied to 0.1 g/tablet.

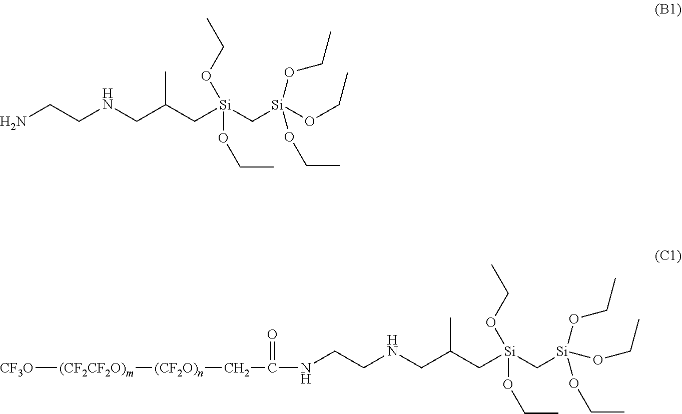

### Example 6

A composition and a film were prepared in the same manner as in Example 1, except that the silane compound (C2) including a fluorine-containing poly(ether) group, prepared in Preparation Example 4, was used, instead of the silane compound (C) including a fluorine-containing poly(ether) group, prepared in Preparation Example 1. Next, the composition was coated on a glass substrate having a thermally deposited 7-nm thick SiO₂ layer by vacuum deposition (dry coating), to thereby form a film having a thickness of about 10 nm.

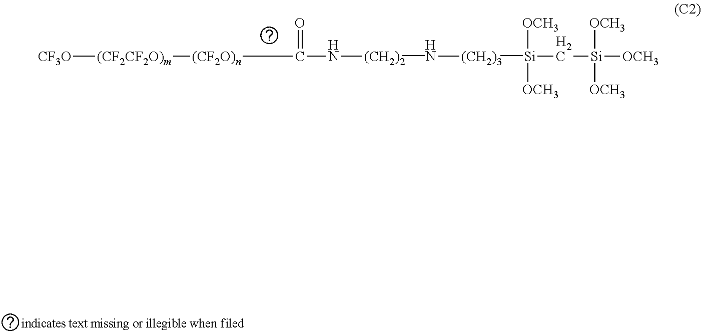

### Comparative Example 1

A composition was obtained in the same manner as in Example 1, except that perfluoropolyethylene (UD-509; available from Daikin, Mw: 4000 g/mol) was used, instead of the composition of Example 1. Next, a film was formed using the composition.

### Reference Example 1

A composition and a film were prepared in the same manner as in Example 1, except that the silane compound (2B-1a) including a fluorine-containing poly(ether) group, prepared in Preparation Example 6, was used, instead of the silane compound (C) including a fluorine-containing poly(ether) group, prepared in Preparation Example 1, and aminosilane (B2) represented below instead of the silane compound (B) was used.

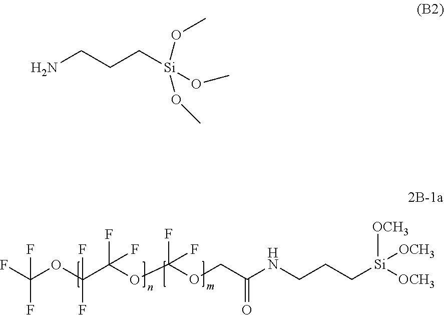

### Reference Example 2

A composition and a film were prepared in the same manner as in Reference Example 1, except that the silane compound (2B-1a) including a fluorine-containing poly(ether) group, prepared in Preparation Example 7, was used.

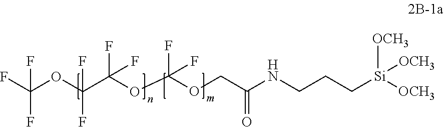

### Reference Example 3

A composition and a film were prepared in the same manner as in Reference Example 1, except that the silane compound (2A-1a) including a fluorine-containing poly(ether) group, prepared in Preparation Example 5, was used.

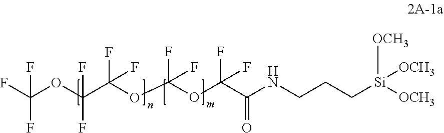

### Evaluation Example 1: Analysis of Durability and Slipperiness

The durability of each of the films of Example 1 to Example 6, Comparative Example 1, and Reference Example 1 to Reference Example 3 was evaluated.

The durability of a film was evaluated by a change in contact angle caused by friction.

An initial contact angle was measured using a sessile-drop technique by dropping a droplet of water onto the film using a Drop shape analyzer (DSA100, KRUSS, Germany). Next, the film was rubbed (15000 times, 20000 times, and 30000 times) using a 6 millimeter (mm)-width polyurethane rubber eraser with 1 kg load, until a change in water contact angle reached about 20° (or until a change in water contact angle exceeded 20°). The changes in water contact angle after the rubbing are shown in Table 1.

The slipperiness of a film was measured by measuring a coefficient of friction (COF) using a coefficient of friction tester (available from LABTHINK Instruments Co., Ltd. (China), Model FPT-F1) according to the standard method described in the manual.

TABLE 1

| | | | Initial | Number | Water contact | Change |
|---|---|---|---|---|---|---|
| | Coated | | water | of wear- | angle (°) after | in water |
| | amount | Slipperiness | contact | resistance | wear-resistance | contact |
| Example | (g/tablet) | (COF) | angle (°) | evaluations | evaluation | angle (Δ) |
| Example 1 | 0.15 | 0.065 | 118.4 | 15k | 113.5 | −4.9 |
| | | 0.054 | 117.7 | 20k | 112.1 | −5.6 |
| | | 0.051 | 117.9 | 30k | 110.6 | −7.3 |
| Example 2 | 0.18 | 0.068 | 115.6 | 20k | 111.5 | −4.1 |
| | | | | 30k | 105.1 | −10.5 |
| Example 3 | 0.15 | 0.051 | 116.4 | 20k | 81.4 | −35 |
| Example 4 | 0.2 | 0.069 | 117.4 | 15k | 115.9 | −1.5 |
| | | | | 30k | 115.6 | −1.8 |
| Example 5 | 0.1 | 0.056 | 118.4 | 30k | 104.7 | −13.7 |
| Example 6 | 0.2 | 0.074 | 119 | 30k | 103.2 | −15.8 |
| Comparative | 0.15 | 0.072 | 117.9 | 15k | 106.5 | −11.4 |
| Example 1 | | | | 20k | 52.4 | −65.5 |
| Reference | 0.15 | 0.052 | 118.6 | 20k | 108.1 | −10.5 |
| Example 1 | | | | 30k | 74 | −44.6 |
| Reference | 0.15 | 0.049 | 119.6 | 20k | 95.8 | −23.8 |
| Example 2 | | | | 30k | 78.2 | −41.4 |
| Reference | 0.15 | 0.069 | 117.7 | 30k | 95 | −22.7 |
| Example 3 | | | | | | |

In Table 1, the coated amount refers to the amount of each sample contained in each tablet and coated by vacuum deposition.

Referring to Table 1, the film of Example 1 was found to have a change in water contact angle of about 4.9°, about 5.6°, and about 7.3° after being rubbed 15000 (15 k) times, 20000 (20 k) times, and 30000 (30 k) times, respectively. The film of Comparative Example 1 was found to have a change in water contact angle of about 11.4° and about 65.5° even after being rubbed 15000 times and 20000 times, respectively, which were significantly greater than the changes in water contact angle in the film of Example 1. The films of Reference Examples 1 to 3 exhibited increased changes in water contact angle after rubbed 20000 times and 30000 times, as compared with the film of Example 1.

The films of Examples 2 to 6 exhibited smaller changes in water contact angle after the rubbing, as compared with the film of Comparative Example 1. The films of Examples 2 and 4 to 6 also exhibited smaller changes in water contact angle after the rubbing, as compared with the films of Reference Example 1 to Reference Example 3.

The above results indicate that the films of Example 1 to Example 6 had improved durability against friction, as compared with the films of Comparative Example 1, Reference Example 1, and Reference Examples 2 and 3.

Referring to Table 1, the films of Examples 1 to 6 were also found to have a COF of 0.1 or less, indicating excellent slipperiness, like the films of Comparative Example 1 and Reference Example 1 to Reference Example 3.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. A silane compound comprising a fluorine-containing poly(ether) group, the silane compound being represented by Formula 1:
Rf-(L¹)ₚ₁-Q1-(L²)ₚ₂-Si(R₁)(R₂)-(L³)ₚ₃-Si(R₃)(R₄)(R₅) Formula 1
wherein, in Formula 1,
Rf is a fluorine-containing poly(ether) group,
Q1 is —O—, —C(═O)O—, —O—C(═O)O—, —NR^{a}C(═O)O—, —C(═O)NR^{b}—, —OC(═O)NR^{c}S(═O)O—, or —CH₂(C₆H₄)C(═O)—, wherein R^{a} to R^{c} are each independently hydrogen, a substituted or unsubstituted C1 to C20 alkyl group, a substituted or unsubstituted C6 to C20 aryl group, or a combination thereof,
L¹ and L³ are each independently a substituted or unsubstituted C1 to C20 alkylene group, a substituted or unsubstituted C1 to C20 oxyalkylene group, or a combination thereof,
L² is a substituted or unsubstituted C1 to C20 alkylene group, a substituted or unsubstituted C1 to C20 oxyalkylene group, —(CH₂)ₘ—NH—(CH₂)ₙ— wherein m and n are each independently an integer of 1 to 10, or a combination thereof,
p1 to p3 are each independently an integer of 1 to 10,
R₁ to R₅ are each independently hydrogen, a substituted or unsubstituted C1 to C20 alkoxy group, a halogen atom, a hydroxyl group, a substituted or unsubstituted C1 to C20 alkyl group, a substituted or unsubstituted C6 to C20 aryl group, or a combination thereof,
wherein
at least one of R₁ to R₅ is a substituted or unsubstituted C1 to C20 alkoxy group, a halogen atom, or a hydroxyl group, or
at least one of R₃ to R₅ is
(L⁴)ₚ₄-Si(R₉)(R₁₀)(R₁₁) or -(L⁴)ₚ₄-Si(R₁₂)(R₁₃)-(L⁵)ₚ₅-Si(R₉)(R₁₀)(R₁₁) and
each of the other R₃ to R₅ is a substituted or unsubstituted C1 to C20 alkoxy group, a halogen atom, or a hydroxyl group,
wherein R₉ to R₁₃ are each independently hydrogen, a substituted or unsubstituted C1 to C20 alkoxy group, a halogen atom, a hydroxyl group, a substituted or unsubstituted C1 to C20 alkyl group, a substituted or unsubstituted C6 to C20 aryl group, or a combination thereof,
wherein, when R₃ to R₅ are each
(L⁴)ₚ₄-Si(R₉)(R₁₀)(R₁₁) or
(L⁴)ₚ₄-Si(R₁₂)(R₁₃)-(L⁵)ₚ₅-Si(R₉)(R₁₀)(R₁₁),
at least one of R₁₁ to R₁₃ is a substituted or unsubstituted C1 to C20 alkoxy group, a halogen atom, or a hydroxyl group,
L⁴ and L⁵ are each independently a substituted or unsubstituted C1 to C20 alkylene group, a substituted or unsubstituted C1 to C20 oxyalkylene group, or a combination thereof, and
p4 and p5 are each independently an integer of 1 to 10.

2. The silane compound of claim 1, wherein in Formula 1, Rf is a perfluoro poly(ether) group.

3. The silane compound of claim 1, wherein in Formula 1, Rf has:
i) a structure having a CF₃O group, a CF₃CF₂O group, or a CF₃CF₂CF₂O group at a terminal thereof, wherein
(CF₂CF₂O)ₙ— and —(CF₂O)ₘ— wherein m and n are each independently an integer of 1 to 100, are bonded to the CF₃O group, the CF₃CF₂O group, or the CF₃CF₂CF₂O group, or
ii) a structure having a CF₃O group, a CF₃CF₂O group, or a CF₃CF₂CF₂O group at a terminal thereof, wherein
(CF₂CF₂O)ₙ—, —(CF₂O)ₘ—, —(CF₂CF₂CF₂O)ₙ—, —(CF₂CF₂CF₂CF₂O)ₙ—, —(CF₂CF₂CF₂CF₂CF₂O)ₙ— wherein m and n are each independently an integer of 1 to 100, are bonded to the CF₃O group, the CF₃CF₂O group, or the CF₃CF₂CF₂O group.

4. The silane compound of claim 1, wherein, in Formula 1, Rf is
CF₃O—(CF₂CF₂O)ₙ—(CF₂O)ₘ—,
CF₃O—(CF₂O)ₘ—(CF₂CF₂O)ₙ,
CF₃CF₂O—(CF₂CF₂O)ₙ—(CF₂O)ₘ,
CF₃CF₂O—(CF₂O)ₘ—(CF₂CF₂O)ₙ—,
CF₃CF₂CF₂O—(CF₂CF₂O)ₙ—(CF₂O)ₘ—, or
CF₃CF₂CF₂O—(CF₂O)ₘ—(CF₂CF₂O)ₙ—,
wherein n and m are each independently an integer of 1 to 100.

5. The silane compound of claim 1, wherein the silane compound of Formula 1 is
CF₃O(CF₂CF₂O)ₙ(CF₂O)ₘ—(CR₁₄R₁₅)ₚ₁—C(═O)NH—(CH₂)ₚ₂—NH—(CH₂)ₚ₃—Si(R₁)(R₂)—(CH₂)ₚ₄—Si(R₃)(R₄)(R₅) or
CF₃O(CF₂CF₂O)ₙ(CF₂O)ₘ—(CR₁₄R₁₅OCR₁₆R₁₇)ₚ₁—C(═O)NH—(CH₂)ₚ₂—NH—(CH₂)ₚ₃—Si(R₁)(R₂)—(CH₂)ₚ₄—Si(R₃)(R₄)(R₅),
wherein
R₁₄ to R₁₇ are each independently hydrogen, C1-C5 alkyl, fluorine, or a fluorinated C1-C5 alkyl group,
p1 to p4 are each independently an integer of 1 to 10,
R₁ to R₅ are each independently hydrogen, a substituted or unsubstituted C1 to C20 alkoxy group, a halogen atom, a hydroxyl group, a substituted or unsubstituted C1 to C20 alkyl group, a substituted or unsubstituted C6 to C20 aryl group, or a combination thereof, and
wherein at least one of R₁ to R₅ in Formula 1 is a C1 to C20 alkoxy group, a halogen atom, or a hydroxyl group.

6. The silane compound of claim 1, wherein the silane compound including a fluorine-containing poly(ether) group being represented by Formula 1 is
CF₃O(CF₂CF₂O)ₙ(CF₂O)ₘ—CH₂—O—CH₂—C(═O)NH—(CH₂)₂—NH—(CH₂)₃—Si(OCH₃)(OCH₃)—CH₂—Si(OCH₃)(OCH₃)(OCH₃),
CF₃O(CF₂CF₂O)ₙ(CF₂O)ₘ—(CH₂)₂—C(═O)NH—(CH₂)₂—NH—(CH₂)₃—Si(OCH₃)(OCH₃)—CH₂—Si(OCH₃)(OCH₃)(OCH₃),
CF₃O(CF₂CF₂O)ₙ(CF₂O)ₘ—(CF₂)₂—C(═O)NH—(CH₂)₂—NH—(CH₂)₃—Si(OCH₃)(OCH₃)—CH₂—Si(OCH₃)(OCH₃)(OCH₃),
CF₃O(CF₂CF₂O)ₙ(CF₂O)ₘ—(CH₂)₂—C(═O)NH—(CH₂)₂—NH—(CH₂)₃—Si(OCH₃)(OCH₃)—CH₂—Si(OCH₃)(OCH₃)(CH₃),
CF₃O(CF₂CF₂O)ₙ(CF₂O)ₘ—(CF₂)₂—C(═O)NH—(CH₂)₂—NH—(CH₂)₃—Si(OCH₃)(OCH₃)—CH₂—Si(OCH₃)(OCH₃)(CH₃), CF₃CF₂O(CF₂CF₂O)ₙ(CF₂O)ₘ—(CH₂)₂—C(═O)NH—(CH₂)₂-NH—(CH₂)₃—Si(OCH₃)(OCH₃)—CH₂—Si(OCH₃)(OCH₃)(OCH₃),
CF₃CF₂O(CF₂CF₂O)ₙ(CF₂O)ₘ—(CF₂)₂—C(═O)NH—(CH₂)₂—NH—(CH₂)₃—Si(OCH₃)(OCH₃)—CH₂—Si(OCH₃)(OCH₃)(OCH₃),
CF₃CF₂O(CF₂CF₂O)ₙ(CF₂O)ₘ—(CH₂)₂—C(═O)NH—(CH₂)₂—NH—(CH₂)₃—Si(OCH₃)(OCH₃)—CH₂—Si(OCH₃)(OCH₃)(CH₃),
CF₃CF₂O(CF₂CF₂O)ₙ(CF₂O)ₘ—(CF₂)₂—C(═O)NH—(CH₂)₂—NH—(CH₂)₃—Si(OCH₃)(OCH₃)—CH₂Si(OCH₃)(OCH₃)(CH₃), CF₃CF₂CF₂O(CF₂CF₂O)ₙ(CF₂O)ₘ—(CH₂)₂—C(═O)NH—(CH₂)₂—NH—(CH₂)₃—Si(OCH₃)(OCH₃)—CH₂—Si(OCH₃)(OCH₃)(OCH₃),
CF₃CF₂CF₂O(CF₂CF₂O)ₙ(CF₂O)ₘ—(CF₂)₂—C(═O)NH—(CH₂)₂—NH—(CH₂)₃—Si(OCH₃)(OCH₃)—CH₂—Si(OCH₃)(OCH₃)(OCH₃),
CF₃CF₂CF₂O(CF₂CF₂O)ₙ(CF₂O)ₘ—(CH₂)₂—C(═O)NH—(CH₂)₂—NH—(CH₂)₃—Si(OCH₃)(OCH₃)—CH₂—Si(OCH₃)(OCH₃)(CH₃), or
CF₃CF₂—CF₂O(CF₂CF₂O)ₙ(CF₂O)ₘ—(CF₂)₂—C(═O)NH—(CH₂)₂—NH—(CH₂)₃—Si(OCH₃)(OCH₃)CH₂Si(OCH₃)(OCH₃)(CH₃).

7. The silane compound of claim 1, wherein in Formula 1, Rf has a weight average molecular weight of about 1,000 grams per mole to about 10,000 grams per mole.

8. A composition comprising the silane compound including a fluorine-containing poly(ether) group according to claim 1.

9. The composition of claim 8, wherein the composition further comprises a compound represented by Formula 3:
A-L⁶-Si(R₅)(R₆)(R₇) Formula 3
wherein, in Formula 3,
L⁶ is a substituted or unsubstituted C1 to C20 alkylene group, a substituted or unsubstituted C6 to C20 arylene group, or a combination thereof,
R₅ to R₇ are each independently hydrogen, a substituted or unsubstituted C1 to C20 alkoxy group, a halogen atom, a hydroxyl group, a substituted or unsubstituted C1 to C20 alkyl group, a substituted or unsubstituted C6 to C20 aryl group, or a combination thereof,
A is a halogen, a thiol group, an isocyanate group, or an amino group, and
at least one of R₅ to R₇ is a substituted or unsubstituted C1 to C20 alkoxy group, a halogen atom, or a hydroxyl group.

10. The composition of claim 9, wherein a mixed molar ratio of the silane compound including a fluorine-containing poly(ether) group and being represented by Formula 1 and the compound being represented by Formula 3 in the composition is about 1:0.003 to about 1:3.

11. The composition of claim 9, wherein the compound being represented by Formula 3 is
H₂N—(CH₂)₃—Si(OCH₃)(OCH₃)(OCH₃),
H₂N—(CH₂)₃—Si(OCH₂CH₃)(OCH₂CH₃)(OCH₂CH₃),
H₂N—(CH₂)₃—Si(OCH₃)(OCH₃)(CH₃), or
H₂N—(CH₂)₃—Si(OCH₂CH₃)(OCH₂CH₃)(CH₂CH₃).

12. The composition of claim 8, wherein the composition further comprises a compound represented by Formula 2:
H₂N-(L²)ₚ₂-Si(R₁)(R₂)-(L³)ₚ₃-Si(R₃)(R₄)(R₅) Formula 2
wherein, in Formula 2,
L² is a substituted or unsubstituted C1 to C20 alkylene group, a substituted or unsubstituted C1 to C20 oxyalkylene group, —(CH₂)ₘ—NH—(CH₂)ₙ— wherein m and n are each independently an integer of 1 to 10, or a combination thereof,
L³ is a substituted or unsubstituted C1 to C20 alkylene group, a substituted or unsubstituted C1 to C20 oxyalkylene group, or a combination thereof,
p2 and p3 are each independently an integer of 1 to 10,
R₁ to R₅ are each independently hydrogen, a substituted or unsubstituted C1 to C20 alkoxy group, a halogen atom, a hydroxyl group, a substituted or unsubstituted C1 to C20 alkyl group, a substituted or unsubstituted C6 to C20 aryl group, or a combination thereof,
wherein
at least one of R₁ to R₅ is a substituted or unsubstituted C1 to C20 alkoxy group, a halogen atom, or a hydroxyl group, or
at least one of R₃ to R₅ is
(L⁴)ₚ₄-Si(R₉)(R₁₀)(R₁₁) or
(L⁴)ₚ₄-Si(R₁₂)(R₁₃)-(L⁵)ₚ₅-S(R₉)(R₁₀)(R₁₁), and
each of the other R₃ to R₅ is a substituted or unsubstituted C1 to C20 alkoxy group, a halogen atom, or a hydroxyl group,
wherein R₉ to R₁₃ are each independently hydrogen, a substituted or unsubstituted C1 to C20 alkoxy group, a halogen atom, a hydroxyl group, a substituted or unsubstituted C1 to C20 alkyl group, a substituted or unsubstituted C6 to C20 aryl group, or a combination thereof, wherein at least one of R₉ to R₁₃ is a substituted or unsubstituted C1 to C20 alkoxy group, a halogen atom, or a hydroxyl group,
L⁴ and L⁵ are each independently a substituted or unsubstituted C1 to C20 alkylene group, a substituted or unsubstituted C1 to C20 oxyalkylene group, or a combination thereof, and
p4 and p5 are each independently an integer of 1 to 10.

13. The composition of claim 12, wherein a mixed molar ratio of the silane compound including a fluorine-containing poly(ether) group and being represented by Formula 1 and the compound being represented by Formula 2 in the composition is about 1:0.5 to about 1:3.

14. A composition comprising a compound represented by Formula 2:
H₂N-(L²)ₚ₂-Si(R₁)(R₂)-(L³)ₚ₃-Si(R₃)(R₄)(R₅) Formula 2
wherein, in Formula 2,
L² is a substituted or unsubstituted C1 to C20 alkylene group, a substituted or unsubstituted C1 to C20 oxyalkylene group, —(CH₂)ₘ—NH—(CH₂)ₙ— wherein m and n are each independently an integer of 1 to 10, or a combination thereof,
L³ is a substituted or unsubstituted C1 to C20 alkylene group, a substituted or unsubstituted C1 to C20 oxyalkylene group, or a combination thereof,
p2 and p3 are each independently an integer of 1 to 10,
R₁ to R₅ are each independently hydrogen, a substituted or unsubstituted C1 to C20 alkoxy group, a halogen atom, a hydroxyl group, a substituted or unsubstituted C1 to C20 alkyl group, a substituted or unsubstituted C6 to C20 aryl group, or a combination thereof,
wherein
at least one of R₁ to R₅ is a substituted or unsubstituted C1 to C20 alkoxy group, a halogen atom, or a hydroxyl group, or
at least one of R₃ to R₅ is
(L⁴)ₚ₄-Si(R₉)(R₁₀)(R₁₁) or
(L⁴)ₚ₄-Si(R₁₂)(R₁₃)-(L⁵)ₚ₅-S(R₉)(R₁₀)(R₁₁), and
each of the other R₃ to R₅ is a substituted or unsubstituted C1 to C20 alkoxy group, a halogen atom, or a hydroxyl group,
wherein R₉ to R₁₃ are each independently hydrogen, a substituted or unsubstituted C1 to C20 alkoxy group, a halogen atom, a hydroxyl group, a substituted or unsubstituted C1 to C20 alkyl group, a substituted or unsubstituted C6 to C20 aryl group, or a combination thereof, wherein at least one of R₉ to R₁₃ is a substituted or unsubstituted C1 to C20 alkoxy group, a halogen atom, or a hydroxyl group,
L⁴ and L⁵ are each independently a substituted or unsubstituted C1 to C20 alkylene group, a substituted or unsubstituted C1 to C20 oxyalkylene group, or a combination thereof, and
p4 and p5 are each independently an integer of 1 to 10.

15. The composition of claim 14, wherein the compound being represented by Formula 2 is
H₂N—(CH₂)ₚ₂—NH—(CH₂)ₚ₃—Si(R₁)(R₂)—(CH₂)ₚ₄—Si(R₃)(R₄)(R₅),
wherein, in Formula 2,
R₁ to R₅ are each independently hydrogen, a substituted or unsubstituted C1 to C20 alkoxy group, a halogen atom, a hydroxyl group, a substituted or unsubstituted C1 to C20 alkyl group, or a combination thereof, wherein at least one of R₁ to R₅ is a C1 to C20 alkoxy group, a halogen atom, or a hydroxyl group, and
p2 to p4 are each independently an integer of 1 to 10.

16. The composition of claim 14, wherein the compound being represented by Formula 2 is
H₂N—(CH₂)₂—NH—(CH₂)₃—Si(OCH₃)(OCH₃)—CH₂—Si(OCH₃)(OCH₃)(OCH₃),
H₂N—(CH₂)₂—NH—(CH₂)₃—Si(OCH₂CH₃)(OCH₂CH₃)—CH₂—Si(OCH₂CH₃)(OCH₂CH₃)(OCH₂CH₃),
H₂N—(CH₂)₂—NH—(CH₂)₃—Si(OCH₃)(OCH₃)—(CH₂)₂—Si(OCH₃)(OCH₃)(OCH₃),
H₂N—(CH₂)₂—NH—(CH₂)₃—Si(OCH₂CH₃)(OCH₂CH₃)—(CH₂)₂—Si(OCH₂CH₃)(OCH₂CH₃) (OCH₂CH₃),
H₂N—(CH₂)₂—NH—(CH₂)₃—Si(OCH₃)(OCH₃)—(CH₂)₃—Si(OCH₃)(OCH₃)(OCH₃),
H₂N—(CH₂)₂—NH—(CH₂)₃—Si(OCH₂CH₃)(OCH₂CH₃)—(CH₂)₃—Si(OCH₂CH₃)(OCH₂CH₃) (OCH₂CH₃),
H₂N—(CH₂)₂—NH—(CH₂)₂—Si(OCH₃)(OCH₃)—CH₂—Si(OCH₃)(OCH₃)(OCH₃),
H₂N—(CH₂)₂—NH—(CH₂)₂—Si(OCH₂CH₃)(OCH₂CH₃)—CH₂—Si(OCH₂CH₃)(OCH₂CH₃)(OCH₂CH₃),
H₂N—(CH₂)₂—NH—(CH₂)₃—Si(OCH₃)(OCH₃)—CH₂—Si(OCH₃)(OCH₃)(CH₃), or
H₂N—(CH₂)₂—NH—(CH₂)₃—Si(OCH₂CH₃)(CH₂CH₃)—CH₂—Si(OCH₂CH₃)(OCH₂CH₃)(CH₂CH₃).

17. The composition of claim 14, further comprising a compound represented by Formula 4:
FpE-(L²)ₚ₁-LG-(L³)ₚ₂-SiR^{a}R^{b}R^{c} Formula 4
wherein, in Formula 4,
FpE is a fluorine-containing poly(ether) moiety,
R^{a}, R^{b} and R^{c} are each independently hydrogen, a substituted or unsubstituted C1 to C20 alkoxy group, a halogen, a hydroxyl group, a substituted or unsubstituted C1 to C20 alkyl group, a substituted or unsubstituted C6 to C20 aryl group, or a combination thereof, wherein at least one of R^{a}, R^{b}, and R^{c} is a substituted or unsubstituted C1 to C20 alkoxy group, a halogen, or a hydroxyl group,
LG is a linking group comprising a hydrogen-bonding functional group,
L² and L³ are each independently a substituted or unsubstituted C1 to C20 alkylene group, a substituted or unsubstituted C6 to C20 arylene group, a substituted or unsubstituted C1 to C20 oxyalkylene group, or a combination thereof, and
p1 and p2 are each independently 0 or an integer of 1 to 10.

18. The composition of claim 17, wherein a mixed molar ratio of the compound being represented by Formula 2 and the compound being represented by Formula 4 in the composition is about 0.003:1 to about 3:1.

19. A film comprising a product of hydrolysis and condensation polymerization of the silane compound including a fluorine-containing poly(ether) group according to

20. The film of claim 19, further comprising a compound represented by Formula 2, a compound represented by Formula 3, or a combination thereof:
H₂N-(L²)ₚ₂-Si(R₁)(R₂)-(L³)ₚ₃-Si(R₃)(R₄)(R₅) Formula 2
wherein, in Formula 2,
L² is a substituted or unsubstituted C1 to C20 alkylene group, a substituted or unsubstituted C1 to C20 oxyalkylene group, —(CH₂)ₘ—NH—(CH₂)ₙ— wherein m and n are each independently an integer of 1 to 10, or a combination thereof,
L³ is a substituted or unsubstituted C1 to C20 alkylene group, a substituted or unsubstituted C1 to C20 oxyalkylene group, or a combination thereof,
p2 and p3 are each independently an integer of 1 to 10,
R₁ to R₅ are each independently hydrogen, a substituted or unsubstituted C1 to C20 alkoxy group, a halogen atom, a hydroxyl group, a substituted or unsubstituted C1 to C20 alkyl group, a substituted or unsubstituted C6 to C20 aryl group, or a combination thereof, wherein at least one of R₁ to R₅ is a substituted or unsubstituted C1 to C20 alkoxy group, a halogen atom, or a hydroxyl group, or
wherein
at least one of R₁ to R₅ is a substituted or unsubstituted C1 to C20 alkoxy group, a halogen atom, or a hydroxyl group, or
at least one of R₃ to R₅ is
(L⁴)ₚ₄-Si(R₉)(R₁₀)(R₁₁) or
(L⁴)ₚ₄-Si(R₁₂)(R₁₃)-(L⁵)ₚ₅-Si(R₉)(R₁₀)(R₁₁), and
each of the other R₃ to R₅ is a substituted or unsubstituted C1 to C20 alkoxy group, a halogen atom, or a hydroxyl group,
R₉ to R₁₃ are each independently hydrogen, a substituted or unsubstituted C1 to C20 alkoxy group, a halogen atom, a hydroxyl group, a substituted or unsubstituted C1 to C20 alkyl group, a substituted or unsubstituted C6 to C20 aryl group, or a combination thereof, wherein at least one of R₉ to R₁₃ is a substituted or unsubstituted C1 to C20 alkoxy group, a halogen atom, or a hydroxyl group,
L⁴ and L⁵ are each independently a substituted or unsubstituted C1 to C20 alkylene group, a substituted or unsubstituted C1 to C20 oxyalkylene group, or a combination thereof, and
p4 and p5 are each independently an integer of 1 to 10,
A-L⁶-Si(R₅)(R₆)(R₇) Formula 3
wherein, in Formula 3,
L⁶ is a substituted or unsubstituted C1 to C20 alkylene group, a substituted or unsubstituted C6 to C20 arylene group, or a combination thereof,
R₅ to R₇ are each independently hydrogen, a substituted or unsubstituted C1 to C20 alkoxy group, a halogen atom, a hydroxyl group, a substituted or unsubstituted C1 to C20 alkyl group, a substituted or unsubstituted C6 to C20 aryl group, or a combination thereof,
A is a halogen, a thiol group, an isocyanate group, or an amino group, and
at least one of R₅ to R₇ is a substituted or unsubstituted C1 to C20 alkoxy group, a halogen atom, or a hydroxyl group.

21. A film comprising:
i) i-1) products of hydrolysis and condensation polymerization of the silane compound including the fluorine-containing poly(ether) group according to claim 1, a silane compound being represented by Formula 4, and i-2) a compound represented by Formula 2, or
ii) products of hydrolysis and condensation polymerization of a mixture including the silane compound including the fluorine-containing poly(ether) group according to claim 1, the silane compound being represented by Formula 4, and the compound represented by Formula 2:
H₂N-(L²)ₚ₂-Si(R₁)(R₂)-(L³)ₚ₃-Si(R₃)(R₄)(R₅) Formula 2
wherein, in Formula 2,
L² is a substituted or unsubstituted C1 to C20 alkylene group, a substituted or unsubstituted C1 to C20 oxyalkylene group, a —(CH₂)ₘ—NH—(CH₂)ₙ— wherein m and n are each independently an integer of 1 to 10, or a combination thereof,
L³ is a substituted or unsubstituted C1 to C20 alkylene group, a substituted or unsubstituted C1 to C20 oxyalkylene group, or a combination thereof,
p2 and p3 are each independently an integer of 1 to 10,
R₁ to R₅ are each independently hydrogen, a substituted or unsubstituted C1 to C20 alkoxy group, a halogen atom, a hydroxyl group, a substituted or unsubstituted C1 to C20 alkyl group, a substituted or unsubstituted C6 to C20 aryl group, or a combination thereof,
wherein
at least one of R₁ to R₅ is a substituted or unsubstituted C1 to C20 alkoxy group, a halogen atom, or a hydroxyl group, or
at least one of R₃ to R₅ is
(L⁴)ₚ₄-Si(R₉)(R₁₀)(R₁₁) or
(L⁴)ₚ₄-Si(R₁₂)(R₁₃)-(L⁵)ₚ₅-Si(R₉)(R₁₀)(R₁₁), and
each of the other R₃ to R₅ is a substituted or unsubstituted C1 to C20 alkoxy group, a halogen atom, or a hydroxyl group,
wherein R₉ to R₁₃ are each independently hydrogen, a substituted or unsubstituted C1 to C20 alkoxy group, a halogen atom, a hydroxyl group, a substituted or unsubstituted C1 to C20 alkyl group, a substituted or unsubstituted C6 to C20 aryl group, or a combination thereof, wherein at least one of R₉ to R₁₃ is a substituted or unsubstituted C1 to C20 alkoxy group, a halogen atom, or a hydroxyl group,
L⁴ and L⁵ are each independently a substituted or unsubstituted C1 to C20 alkylene group, a substituted or unsubstituted C1 to C20 oxyalkylene group, or a combination thereof, and
p4 and p5 are each independently an integer of 1 to 10,
FpE-(L²)ₚ₁-LG-(L³)ₚ₂-SiR^{a}R^{b}R^{c} Formula 4
wherein, in Formula 4,
FpE is a fluorine-containing poly(ether) moiety,
R^{a}, R^{b}, and R^{c} are each independently hydrogen, a substituted or unsubstituted C1 to C20 alkoxy group, a halogen, a hydroxyl group, a substituted or unsubstituted C1 to C20 alkyl group, a substituted or unsubstituted C6 to C20 aryl group, or a combination thereof, wherein at least one of R^{a}, R^{b}, and R^{c} is a substituted or unsubstituted C1 to C20 alkoxy group, a halogen, or a hydroxyl group,
LG is a linking group comprising a hydrogen-bonding functional group,
L² and L³ are each independently a substituted or unsubstituted C1 to C20 alkylene group, a substituted or unsubstituted C6 to C20 arylene group, a substituted or unsubstituted C1 to C20 oxyalkylene group, or a combination thereof, and
p1 and p2 are each independently 0 or an integer of 1 to 10.

22. A display device comprising:
a film comprising
i) products of hydrolysis and condensation polymerization of the silane compound including the fluorine-containing poly(ether) group according to claim 1, or
a film comprising
ii) ii-1) products of hydrolysis and condensation polymerization of the silane compound including a fluorine-containing poly(ether) group, a silane compound being represented by Formula 4, and ii-2) a compound represented by Formula 2:
H₂N-(L²)ₚ₂-Si(R₁)(R₂)-(L³)ₚ₃-Si(R₃)(R₄)(R₅) Formula 2
wherein, in Formula 2,
L² is a substituted or unsubstituted C1 to C20 alkylene group, a substituted or unsubstituted C1 to C20 oxyalkylene group, a —(CH₂)ₘ—NH—(CH₂)ₙ— wherein m and n are each independently an integer of 1 to 10, or a combination thereof,
L³ is a substituted or unsubstituted C1 to C20 alkylene group, a substituted or unsubstituted C1 to C20 oxyalkylene group, or a combination thereof,
p2 and p3 are each independently an integer of 1 to 10,
R₁ to R₅ are each independently hydrogen, a substituted or unsubstituted C1 to C20 alkoxy group, a halogen atom, a hydroxyl group, a substituted or unsubstituted C1 to C20 alkyl group, a substituted or unsubstituted C6 to C20 aryl group, or a combination thereof,
wherein,
at least one of R₁ to R₅ is a substituted or unsubstituted C1 to C20 alkoxy group, a halogen atom, or a hydroxyl group, or
at least one of R₃ to R₅ is
(L⁴)ₚ₄-Si(R₉)(R₁₀)(R₁₁) or
(L⁴)ₚ₄-Si(R₁₂)(R₁₃)-(L⁵)ₚ₅-S(R₉)(R₁₀)(R₁₁), and
each of the other R₃ to R₅ is a substituted or unsubstituted C1 to C20 alkoxy group, a halogen atom, or a hydroxyl group,
wherein
R₉ to R₁₃ are each independently hydrogen, a substituted or unsubstituted C1 to C20 alkoxy group, a halogen atom, a hydroxyl group, a substituted or unsubstituted C1 to C20 alkyl group, a substituted or unsubstituted C6 to C20 aryl group, or a combination thereof,
at least one of R₉ to R₁₃ is a substituted or unsubstituted C1 to C20 alkoxy group, a halogen atom, or a hydroxyl group,
L⁴ and L⁵ are each independently a substituted or unsubstituted C1 to C20 alkylene group, a substituted or unsubstituted C1 to C20 oxyalkylene group, or a combination thereof, and
p4 and p5 are each independently an integer of 1 to 10,
FpE-(L²)ₚ₁-LG-(L³)ₚ₂-SiR^{a}R^{b}R^{c} Formula 4
wherein, in Formula 4,
FpE is a fluorine-containing poly(ether) moiety,
R^{a}, R^{b}, and R^{c} are each independently hydrogen, a substituted or unsubstituted C1 to C20 alkoxy group, a halogen, a hydroxyl group, a substituted or unsubstituted C1 to C20 alkyl group, a substituted or unsubstituted C6 to C20 aryl group, or a combination thereof, wherein at least one of R^{a}, R^{b}, and R^{c} is a substituted or unsubstituted C1 to C20 alkoxy group, a halogen, or a hydroxyl group,
LG is a linking group comprising a hydrogen-bonding functional group,
L² and L³ are each independently a substituted or unsubstituted C1 to C20 alkylene group, a substituted or unsubstituted C6 to C20 arylene group, a substituted or unsubstituted C1 to C20 oxyalkylene group, or a combination thereof, and
p1 and p2 are each independently 0 or an integer of 1 to 10.

23. An article obtained by coating, onto a surface of the article, a composition comprising:
the silane compound including the fluorine-containing poly(ether) group according to claim 1 and being represented by Formula 1, or
a composition comprising a compound represented by Formula 2:
H₂N-(L²)ₚ₂-Si(R₁)(R₂)-(L³)ₚ₃-Si(R₃)(R₄)(R₅) Formula 2
wherein, in Formula 2,
L² is a substituted or unsubstituted C1 to C20 alkylene group, a substituted or unsubstituted C1 to C20 oxyalkylene group, a —(CH₂)ₘ—NH—(CH₂)ₙ— wherein m and n are each independently an integer of 1 to 10, or a combination thereof,
L³ is a substituted or unsubstituted C1 to C20 alkylene group, a substituted or unsubstituted C1 to C20 oxyalkylene group, or a combination thereof,
p2 and p3 are each independently an integer of 1 to 10,
R₁ to R₅ are each independently hydrogen, a substituted or unsubstituted C1 to C20 alkoxy group, a halogen atom, a hydroxyl group, a substituted or unsubstituted C1 to C20 alkyl group, a substituted or unsubstituted C6 to C20 aryl group, or a combination thereof,
wherein
at least one of R₁ to R₅ is a substituted or unsubstituted C1 to C20 alkoxy group, a halogen atom, or a hydroxyl group, or
at least one of R₃ to R₅ is
(L⁴)ₚ₄-Si(R₉)(R₁₀)(R₁₁) or
(L⁴)ₚ₄-Si(R₁₂)(R₁₃)-(L⁵)ₚ₅-S(R₉)(R₁₀)(R₁₁), and
each of the other R₃ to R₅ is a substituted or unsubstituted C1 to C20 alkoxy group, a halogen atom, or a hydroxyl group,
wherein
R₉ to R₁₃ are each independently hydrogen, a substituted or unsubstituted C1 to C20 alkoxy group, a halogen atom, a hydroxyl group, a substituted or unsubstituted C1 to C20 alkyl group, a substituted or unsubstituted C6 to C20 aryl group, or a combination thereof, wherein at least one of R₉ to R₁₃ is a substituted or unsubstituted C1 to C20 alkoxy group, a halogen atom, or a hydroxyl group, and
L⁴ and L⁵ are each independently a substituted or unsubstituted C1 to C20 alkylene group, a substituted or unsubstituted C1 to C20 oxyalkylene group, or a combination thereof, and
p4 and p5 are each independently an integer of 1 to 10.
